(19) United States
(12) Patent Application Publication
(10) Pub. No.: US 2022/0244285 A1
(43) Pub. Date: Aug. 4, 2022

(54) STANDARD SAMPLE CONTAINER AND AUTOMATIC ANALYZER

(71) Applicant: Canon Medical Systems Corporation, Otawara-shi (JP)

(72) Inventor: Shozo HASHIMOTO, Nasushiobara (JP)

(73) Assignee: Canon Medical Systems Corporation, Otawara-shi (JP)

(21) Appl. No.: 17/588,911

(22) Filed: Jan. 31, 2022

(30) Foreign Application Priority Data
Feb. 2, 2021 (JP) 2021-014894

(51) Int. Cl. G01N 35/10; G01N 35/00; G01N 35/02; B01L 3/00

(52) U.S. Cl. CPC G01N 35/1009; G01N 35/00693; G01N 2035/00702; B01L 3/52; G01N 35/025

(57) ABSTRACT

According to one embodiment, a standard sample container includes a soft container, a discharging mechanism, and a chamber. The soft container is adapted to contain a standard sample for use in preparing a calibration curve or managing accuracy for an automatic analyzer. The discharging mechanism is adapted to discharge the standard sample present in the soft container into a reaction container via a dispensing nozzle. The chamber is adapted to accommodate the soft container.

### CROSS-REFERENCE TO RELATED APPLICATIONS

This application is based upon and claims the benefit of priority from prior Japanese Patent Application No. 2021-014894, filed Feb. 2, 2021, the entire contents of which are incorporated herein by reference.

### FIELD

Embodiments described herein relate generally to a standard sample container and an automatic analyzer.

### BACKGROUND

Standard sample containers for use with an automatic analyzer generally involve a risk of exposing an inside standard sample to the outside air. This could degrade the quality of the standard sample by oxidation, evaporation, contamination, dilution with dew condensation water, etc. If, for example, such quality degradation of the standard sample is a concentration change, a test could return a relative outlier even with a problem-free subject sample, and this would incur a problematic result. It is therefore desirable that standard sample containers be adapted to suppress quality degradation of a standard sample.

### BRIEF DESCRIPTION OF THE DRAWINGS

FIG. 1 is a block diagram showing a functional configuration of an automatic analyzer according to a first embodiment.

FIG. 2 is a schematic diagram of an exemplary design of components pertaining to the automatic analyzer according to the first embodiment, with one or more standard sample containers according to the embodiment.

FIG. 3 is a schematic diagram for explaining one example of a structure of the standard sample container according to the first embodiment.

FIG. 4 is another schematic diagram for explaining said one example of the structure of the standard sample container according to the first embodiment.

FIG. 5 is yet another schematic diagram for explaining said one example of the structure of the standard sample container according to the first embodiment.

FIG. 6 is a flowchart for explaining operations in the first embodiment.

FIG. 7 sets forth schematic diagrams for explaining the operations in the first embodiment.

FIG. 8 is a schematic diagram of an exemplary design of components pertaining to an automatic analyzer according to a second embodiment, with one or more standard sample containers according to the embodiment.

FIG. 9 is a schematic diagram for explaining one example of the structure of the standard sample container according to the second embodiment.

FIG. 10 is another schematic diagram for explaining said one example of the structure of the standard sample container according to the second embodiment.

FIG. 11 is a flowchart for explaining operations in the second embodiment.

FIG. 12 sets forth schematic diagrams for explaining the operations in the second embodiment.

FIG. 13 is a schematic diagram of an exemplary design of components pertaining to an automatic analyzer according to a third embodiment, with standard sample containers according to the embodiment.

FIG. 14 is a flowchart for explaining operations in the third embodiment.

FIG. 15 sets forth schematic diagrams for explaining the operations in the third embodiment.

FIG. 16 is a schematic diagram for explaining one example of an automatic analyzer with a standard sample container, set forth as a fourth embodiment.

FIG. 17 is a schematic diagram for explaining one example of a sampler with standard sample containers according to a modification of the fourth embodiment.

FIG. 18 is a schematic diagram for explaining operations in the modification of the fourth embodiment.

FIG. 19 is a flowchart for explaining operations of an automatic analyzer according to a fifth embodiment.

FIG. 20 is a flowchart for explaining operations of an automatic analyzer according to a sixth embodiment.

### DETAILED DESCRIPTION

In general, according to one embodiment, a standard sample container includes a soft container, a discharging mechanism, and a chamber. The soft container is adapted to contain a standard sample for use in preparing a calibration curve or managing accuracy for an automatic analyzer. The discharging mechanism is adapted to discharge the standard sample present in the soft container into a reaction container via a dispensing nozzle. The chamber is adapted to accommodate the soft container.

The embodiments will be described with reference to the drawings.

### First Embodiment

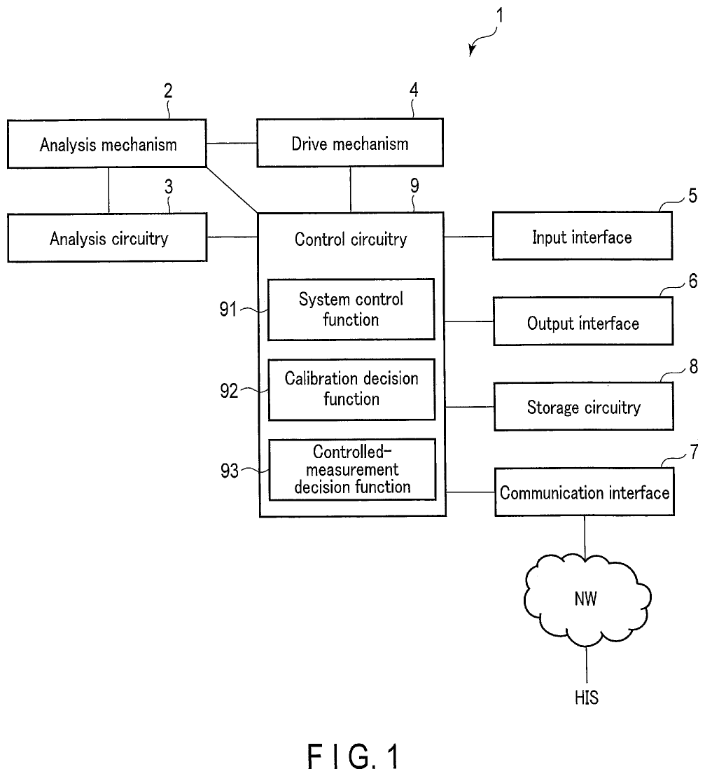

FIG. 1 is a block diagram showing a functional configuration of an automatic analyzer according to the first embodiment. As shown in FIG. 1, the automatic analyzer according to this embodiment, denoted by “1”, includes an analysis mechanism 2, analysis circuitry 3, a drive mechanism 4, an input interface 5, an output interface 6, a communication interface 7, storage circuitry 8, and control circuitry 9.

The analysis mechanism 2 mixes a sample, such as a standard sample or a subject sample, with a reagent for the test item set for the sample. The analysis mechanism 2 subjects the mixture liquid of the sample and the reagent to measurement and generates standard data and subject data, which may be represented as, for example, absorbency levels. The standard sample may be called a “calibrator”.

The analysis circuitry 3 is a processor to analyze the standard data and the subject data, generated by the analysis mechanism 2, to generate calibration data and analysis data. The analysis circuitry 3 reads an analysis program from the storage circuitry 8 and generates the calibration data, the analysis data, etc., according to the read analysis program. For example, the calibration data is indicative of a relationship between the standard data and a standard value predetermined for the standard sample, and the analysis circuitry 3 generates this calibration data based on the standard data. Also, the analysis data may be represented as a concentration value and an enzyme activity value, and the analysis circuitry 3 generates this analysis data based on the subject data and the calibration data for the test item corresponding to the subject data. The analysis circuitry 3 outputs the generated data including the calibration data, the analysis data, etc. to the control circuitry 9.

The drive mechanism 4 drives the analysis mechanism 2 under the control of the control circuitry 9. The drive mechanism 4 is realized by, for example, a gear, a stepping motor, a belt conveyor, a lead screw, and so on.

The input interface 5 accepts, for example, settings for analysis parameters, etc., associated with each test item intended for a measurement-requested blood sample, from an operator or via an in-hospital network NW. The input interface 5 is realized by, for example, one or more of a mouse, a keyboard, a touch pad on which instructions are input by touching an operation screen, and the like. The input interface 5 is connected to the control circuitry 9 so that it converts operational commands input by an operator into electric signals and outputs them to the control circuitry 9. In the disclosure herein, the input interface 5 is not limited to physical operating components such as a mouse and a keyboard. Examples of the input interface 5 also include processing circuitry for electric signals, which is adapted to receive an electric signal corresponding to an operational command input from an external input device separate from the automatic analyzer 1, and to output this electric signal to the control circuitry 9.

The output interface 6 is connected to the control circuitry 9 and outputs signals coming from the control circuitry 9. The output interface 6 is realized by, for example, one or more of display circuitry, print circuitry, an audio device, and the like. Such display circuitry may be a CRT display, a liquid crystal display, an organic EL display, an LED display, a plasma display, etc. Also, the display circuitry may include processing circuitry for converting data of a display subject into video signals and supplying the video signals to external entities. The print circuitry may be a printer, etc. The print circuitry may also include output circuitry for supplying data of a print subject to external entities. The audio device may be a speaker, etc. Examples of the audio device also include output circuitry for supplying audio signals to external entities.

The communication interface 7 is connected to, for example, the in-hospital network NW. The communication interface 7 performs data communication with a hospital information system (HIS) via the in-hospital network NW. It is also possible for the communication interface 7 to perform data communication with the. HIS via a laboratory information system (LIS) connected to the in-hospital network NW.

The storage circuitry 8 may be, for example, a processor-readable storage medium such as a magnetic or an optical storage medium or a semiconductor memory. Note that it is not required to realize the storage circuitry 8 by a single storage medium or device. For example, the storage circuitry 8 may be realized by multiple storage devices.

The storage circuitry 8 stores analysis programs for the analysis circuitry 3 to execute, and control programs for the control circuitry 9 to realize its functions. The storage circuitry 8 stores, for each test item, the calibration data generated by the analysis circuitry 3. The storage circuitry 8 also stores, for each sample, the analysis data generated by the analysis circuitry 3. The storage circuitry 8 stores a test order input from an operator, or a test order received by the communication interface 7 via the in-hospital network NW.

The control circuitry 9 is, for example, a processor functioning as a center of the automatic analyzer 1. The control circuitry 9 executes the programs stored in the storage circuitry 8 to realize functions corresponding to the executed programs. For example, the control circuitry 9 executes one or more control programs to realize a system control function 91, a calibration decision function 92, and a controlled-measurement decision function 93. Note that the present embodiment will be described assuming that a single processor realizes the system control function 91, the calibration decision function 92, and the controlled-measurement decision function 93. However, the embodiment is not limited to such a configuration. For example, multiple independent processors may be used in combination to form the control circuitry to have the respective processors execute the control programs, so that the system control function 91, the calibration decision function 92, and the controlled-measurement decision function 93 will be realized. Note also that the control circuitry 9 is assumed to have such discrete functions for descriptive purposes, and the functions of the control circuitry 9 are not limited by the explanation herein. For example, each function of the control circuitry 9 may be partially or entirely incorporated into the system control function 91, or the system control function 91 may be partially incorporated into the calibration decision function 92 and/or the controlled-measurement decision function 93.

The system control function 91 is a function to take total control over the components of the automatic analyzer 1 according to the input information input via the input interface 5. For example, the control circuitry 9 controls each component so that measurement with a sample, calibration measurement with a standard sample, controlled measurement with a standard sample, etc. will be performed. Here, calibration measurement refers to a measurement operation for preparing a fresh calibration curve. Controlled measurement refers to a measurement operation required for managing the accuracy of prepared calibration curves or a currently set calibration curve. More specifically, for these measurement operations, the control circuitry 9 controls the drive mechanism 4 and also the analysis mechanism 2 for operational actions such as the rotation of a reaction disk 201, the pivoting and dispensing action of a sample dispensing probe 207, and the rotation and discharging action of one or more reagent racks, as will be described. The control circuitry 9 also controls the analysis circuitry 3 to perform analysis corresponding to the test items. The control circuitry 9 may be provided with a storage area for storing at least a portion of the data stored in the storage circuitry 8. The system control function 91 is one example of a measurer for conducting measurement for preparing a calibration curve and measurement for managing its accuracy, through the use of a standard sample. The measurement for preparing a calibration curve may be called “calibration measurement”. The measurement for accuracy management may be called “fresh controlled measurement”.

The calibration decision function 92 is a function to decide whether or not the calibration measurement using a standard sample is necessary. If it is decided that the calibration measurement is necessary, the calibration decision function 92 makes the system control function 91 start the calibration measurement. The calibration decision function 92 is one example of a decider.

The controlled-measurement decision function 93 is a function to decide whether or not the controlled measurement using a standard sample is necessary. If it is decided that the controlled measurement is necessary, the controlled-measurement decision function 93 makes the system control function 91 start the controlled measurement. The controlled-measurement decision function 93 is another example of the decider.

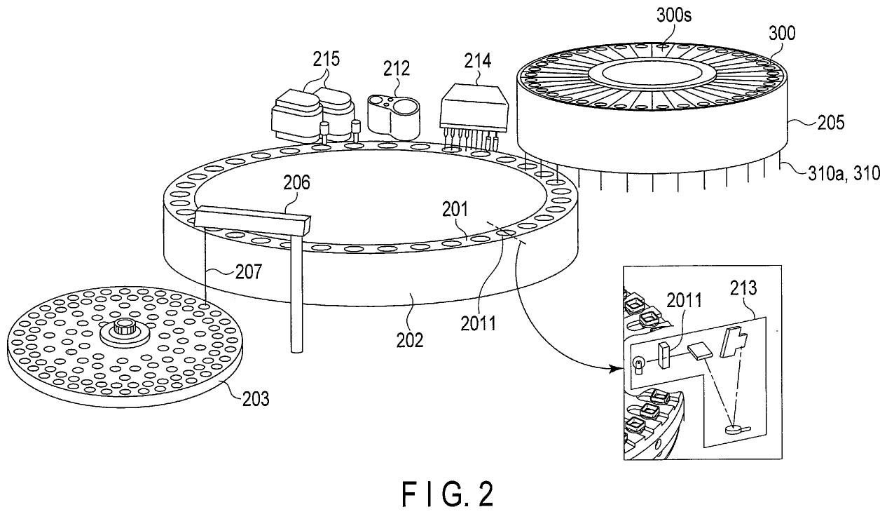

FIG. 2 is a schematic diagram of an exemplary design of the analysis mechanism 2 shown in FIG. 1. The analysis mechanism 2 includes the aforementioned reaction disk 201, a constant temperature part 202, a sample disk 203, and a reagent depository 205. The analysis mechanism 2 also includes a sample dispensing arm 206, the aforementioned sample dispensing probe 207, an electrode unit 212, a photometry unit 213, a washing unit 214, and a stirring unit 215. The sample disk 203 may be called a “disk sampler” or a “sampler”.

The reaction disk 201 holds multiple reaction containers 2011 in an annular arrangement. Note that these reaction containers 2011 in the figure are shown as sparsely arranged, relatively large circle marks on the reaction disk 201. However, in practical instances, the reaction containers 2011 are each expressed as a small quadrilateral object (a top of a cuvette) as shown on the left of the photometry unit 213, and are densely arranged. As one concrete configuration, the reaction disk 201 is turned and stopped in an alternating manner by the drive mechanism 4, and this alternating motion is repeated at regular time intervals, e.g., every 4.5 seconds (hereinafter, each time interval will be called “one time period” or “one cycle”). The reaction containers 2011 may be formed of, for example, a glass material, a polypropylene (PP) material, or an acrylic material. There are multiple positions set on the reaction disk 201, including one or more sample discharging positions, reagent discharging positions, and stirring positions. Each reagent discharging position is set at a location of the reaction container 2011 that faces a dispensing nozzle 310 of a reagent container 300 or a standard sample container 300s kept in the reagent depository 205. The reaction disk 201 is one example of a rotary table for holding multiple reaction tubes in a rotatable manner. The automatic analyzer 1 is adapted so that it can dispense a sample to one of the reaction tubes that is located at a first position, and dispense a reagent from the reagent depository 205 to one of the reaction tubes that is located at a second position.

The constant temperature part 202 stores a thermal medium set at a predetermined temperature. By immersing the reaction containers 2011 in the stored thermal medium, the constant temperature part 202 increases the temperature of the mixture liquid contained in the reaction containers 2011.

The sample disk 203 holds multiple sample containers each containing a measurement-requested sample (a subject sample), in an annular arrangement. The sample disk 203 conveys the sample containers along a predetermined path. In the example shown in FIG. 2, the sample disk 203 is disposed next to the reaction disk 201. One or more sample aspirating positions are set on predetermined positions of the sample disk 203. The sample disk 203 may be covered by a detachable cover.

The reagent depository 205 keeps multiple containers at low temperature, including a reagent container 300 airtightly containing a first reagent, a reagent container 300 airtightly containing a second reagent, and a standard sample container 300s airtightly containing a standard sample. In the example shown in FIG. 2, the reagent depository 205 is provided above a portion of the reaction disk 201. Here, the first reagent is for reaction with a given component in a sample. The second reagent is dispensed after the first reagent is dispensed. The reagent depository 205 encloses one or more reagent racks in such a manner that the reagent racks can turn. The reagent racks can hold the multiple reagent containers 300 and standard sample containers 300s in an annular arrangement. The reagent racks are turned by the drive mechanism 4. One or more reagent discharging positions, each indicative of the location of the dispensing nozzle 310 of one reagent container 300 or one standard sample container 300s, are set on the reagent depository 205. The reagent depository 205 may be covered by a detachable cover.

Next, the sample dispensing arm 206, the sample dispensing probe 207, the electrode unit 212, the photometry unit 213, the washing unit 214, and the stirring unit 215 will be described.

The sample dispensing arm 206 is provided between the reaction disk 201 and the sample disk 203. The sample dispensing arm 206 is adapted so that it can vertically ascend and descend, and also horizontally rotate, with the assistance of the drive mechanism 4. The sample dispensing arm 206 carries the sample dispensing probe 207 at its one end.

The sample dispensing probe 207 pivots along an arc circling trajectory in conjunction with the rotation of the sample dispensing arm 206. This circling trajectory runs through each sample aspirating position and each sample discharging position. The sample aspirating position corresponds to, for example, an intersection between the circling trajectory of the sample dispensing probe 207 and the traveling path of the sample containers held in an annular arrangement by the sample disk 203. Also, the sample discharging position corresponds to, for example, an intersection between the circling trajectory of the sample dispensing probe 207 and the traveling path of the reaction containers 2011 held in an annular arrangement by the reaction disk 201.

The sample dispensing probe 207 is driven by the drive mechanism 4 so that it ascends or descends at a position directly above the opening of the sample container held by the sample disk 203 (i.e., the sample aspirating position), or at a position directly above the opening of the reaction container 2011 held by the reaction disk 201 (i.e., the sample discharging position).

Under the control of the control circuitry 9, the sample dispensing probe 207 aspirates a sample from the sample container directly below it at the sample aspirating position. Also under the control of the control circuitry 9, the sample dispensing probe 207 discharges the aspirated sample to the reaction container 2011 directly below it at the sample discharging position. The sample dispensing probe 207 performs a series of dispensing motions including such aspiration and discharge, for example, once in one cycle.

The electrode unit 212 is disposed near the outer circumference of the reaction disk 201. The electrode unit 212 measures an electrolyte concentration of the mixture liquid of the sample and the reagent that have been discharged into the reaction container 2011. The electrode unit 212 includes an ion selective electrode (ISE) and a reference electrode. Under the control of the control circuitry 9, the electrode unit 212 measures an electric potential between the ISE and the reference electrode for the mixture liquid containing measurement target ions. The electrode unit 212 outputs data about the measured electric potential, which serves as either standard data or subject data, to the analysis circuitry 3.

The photometry unit 213 is disposed near the outer circumference of the reaction disk 201. The photometry unit 213 optically measures given components in the mixture liquid of the sample and the reagent that have been discharged into the reaction container 2011. The photometry unit 213 includes a light source and a photodetector. Under the control of the control circuitry 9, the photometry unit 213 emits light from the light source. The emitted light enters the reaction container 2011 through a first sidewall and exits the reaction container 2011 through a second sidewall opposite the first sidewall. The photometry unit 213 detects the light coming out of the reaction container 2011 by the photodetector.

More specifically, and for example, the photodetector detects the light that has passed through the mixture liquid of the standard sample and the reagent in the reaction container 2011, and generates standard data represented as an absorbency level, etc., based on the intensity of the detected light. The photodetector also detects the light that has passed through the mixture liquid of the subject sample and the reagent in the reaction container 2011, and generates subject data represented as an absorbency level, etc., based on the intensity of the detected light. The photometry unit 213 outputs the generated standard data and subject data to the analysis circuitry 3.

The washing unit 214 is disposed near the outer circumference of the reaction disk 201. The washing unit 214 washes the inside of each reaction container 2011 for which the measurement of the mixture liquid by the electrode unit 212 or the photometry unit 213 has been finished. The washing unit 214 includes a washing liquid supply pump (not shown in the figure) for supplying a washing liquid to wash the reaction containers 2011. The washing unit 214 also includes a washing nozzle adapted to discharge the washing liquid supplied from the washing liquid supply pump into the reaction container 2011, and to suction each of the mixture liquid and the washing liquid remaining in the reaction container 2011.

The stirring unit 215 is disposed near the outer circumference of the reaction disk 201. The stirring unit 215 includes a stirring tool, and uses this stirring tool to stir the mixture liquid of the sample and the first reagent present in the reaction container 2011 located at the stirring position on the reaction disk 201. When appropriate, the stirring unit 215 stirs the mixture liquid of the sample, the first reagent, and the third reagent present in the reaction container 2011.

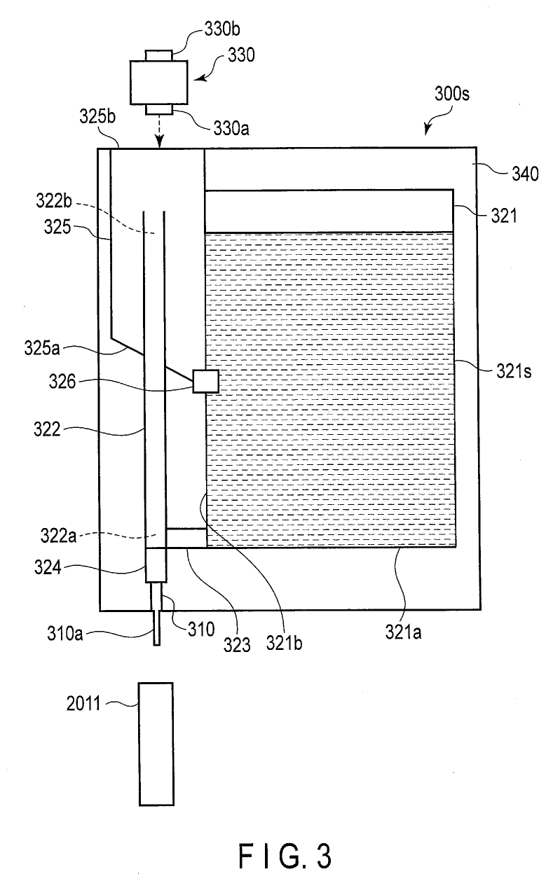

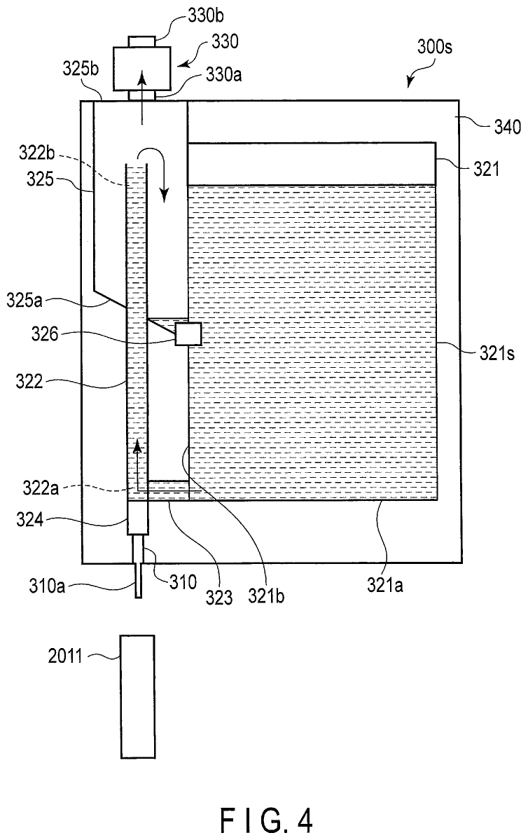

A description will be given of one example of the standard sample container 300s for use with the automatic analyzer 1 configured as above, with reference to FIGS. 3 to 5. FIG. 3 is a schematic diagram showing one exemplary sectional structure of each standard sample container 300s. Note, however, that the standard sample container 300s is not limited to the structures shown in FIGS. 3 to 5. Note also that a supply pump unit 330 shown in FIG. 3 is not a component of the standard sample container 300s. The standard sample container 300s is one example of a standard sample container.

The standard sample container 300s is constituted by a case 340, the aforementioned dispensing nozzle 310 disposed in the case 340, and a standard sample supply unit.

The case 340 has a through-hole in its bottom, through which a tip 310a of the dispensing nozzle 310 comes out.

The standard sample container 300s includes a container 321, a cylinder 322, one-way valves 323 and 324, another container 325, and an electromagnetic valve 326.

The container 321 has, for example, a dual structure for containing a standard sample. In one example, the container 321 includes a casing, and a pouch-like soft container 321s enclosed in this casing. The casing is formed of, for example, a metal material or a polymer material. The casing is one example of a chamber for accommodating a soft container. The standard sample here is a liquid which contains a measurement target substance at a given concentration. More specifically, and for example, the standard sample is a solution in which a component to be analyzed for a test item is contained at a known concentration. The soft container 321s is a flexible container in which the standard sample for use in preparing a calibration curve or managing the accuracy for the automatic analyzer 1 is airtightly contained. The soft container 321s is formed of a material softer or more flexible than the casing, and such a material may be, for example, a resin film. Examples of the material of the soft container 321s include a polymer material selected from the group consisting of polyethylene, polytetrafluoroethylene, polypropylene, polyurethane, polyvinylidene chloride, polyvinyl chloride, polyacetal, polystyrene, polyacrylonitrile, and polybutylene. The soft container 321s is constituted by a film (resin film) of the selected polymer material or materials. Use of this soft container 321s enables the container 321 to prevent the standard sample from being exposed to air.

Also, the soft container 321s is formed with one or more creases. When the standard sample flows from the container 321 and enters the cylinder 322 via the one-way valve 323, the amount of the standard sample in the soft container 321s decreases. At the same time, the liquid level of the standard sample in the container 321 drops, and the soft container 321s having one or more creases shrinks. The container 321 can accordingly suppress the foam generation from the standard sample during its movement, such as when the standard sample container 300s is conveyed, or when the rotary table is rotated after the conveyance of the standard sample container 300s. To be more specific, since the standard sample in the container 321 is sealed in the soft container 321s formed of a soft material, e.g., a resin film, the standard sample foams very little due to ruffles in its surface. For the sake of convenience, the description will simply state that the standard sample is contained in the container 321.

The one-way valve 323 is provided between the cylinder 322 and the container 321. More specifically, the one-way valve 323 is provided between the side face of the cylinder 322 near its tip 322a and the side face of the container 321 near its bottom 321a. For example, the one-way valve 323 permits the standard sample to flow from the inside of the container 321 into the cylinder 322 in response to a medium drawing action of the supply pump unit 330, which will be described later. Here, the one-way valve 323 is adapted to block a back-flow in the direction from the cylinder 322 toward the container 321. The one-way valve 323 may be called a “check valve”. The one-way valve 323 is one example of a second valve provided at a position in a discharging mechanism which is closer to the soft container 321s than the one-way valve 324. The second valve serves to block a back-flow from the discharging mechanism to the inside of the soft container 321s.

The one-way valve 324 is provided between the cylinder 322 and the dispensing nozzle 310. More specifically, the one-way valve 324 is provided between the tip 322a of the cylinder 322 and an end of the dispensing nozzle 310 opposite the tip 310a. For example, the one-way valve 324 permits the standard sample to be discharged from the inside of the cylinder 322 and then the dispensing nozzle 310 in response to a medium ejecting action of the supply pump unit 330, which will be described later. Here, the one-way valve 324 is adapted to block a back-flow in the direction from the dispensing nozzle 310 toward the cylinder 322. The one-way valve 324 may be called a “check valve”. The one-way valve 324 is one example of a first valve provided at a tip-side position in the discharging mechanism, for blocking a back-flow from the dispensing nozzle 310 to the discharging mechanism.

The cylinder 322 has a portion from which the medium is drawn and to which the medium is ejected. More specifically, the cylinder 322 has an end 322b opposite the tip 322a. When the medium is drawn through this end 322b by the supply pump unit 330 (described later), the standard sample flows from the container 321 and enters the cylinder 322 via the one-way valve 323. Here, the standard sample enters the cylinder 322 in an amount based on the amount set as an analysis parameter for the test item. Also, when the medium is ejected through the end 322b of the cylinder 322 by the supply pump unit 330 (described later), the standard sample that has entered the cylinder 322 is discharged from the dispensing nozzle 310 via the one-way valve 324. The cylinder 322 is one example of the discharging mechanism for discharging the standard sample present in the soft container 321s from the dispensing nozzle 310 to the reaction container 2011.

The container 325 contacts portions of a side face 321b and a top of the container 321, and accommodates the end 322b of the cylinder 322. More specifically, the cylinder 322 penetrates through a bottom 325a of the container 325 so that the end 322b is located within the container 325. The container 325 is adapted to hold the standard sample that overflows from the end 322b of the cylinder 322 when the standard sample flows into the cylinder 322 from the container 321 via the one-way valve 323.

Note that the bottom 325a of the container 325 slopes downward as it approaches the side face 321b of the container 321. In other words, the bottom 325a of the container 325 is formed in such a shape as to guide, within the container 325, the standard sample overflowing from the end 322b of the cylinder 322 toward the side face 321b of the container 321, so that the overflow standard sample is held in the container 325.

The electromagnetic valve 326 is disposed in a region where the bottom 325a of the container 325 and the side face 321b of the container 321 meet each other. The electromagnetic valve 326 couples the container 325 with the container 321 at the releasing operation. For example, the electromagnetic valve 326 is opened under the control of the control circuitry 9, thereby releasing the standard sample to flow into the container 321 from the container 325 via the electromagnetic valve 326. That is, the standard sample held in the container 325 is returned to the container 321.

As shown in FIG. 3, the supply pump unit 330 includes a pump head 330a and a terminal 330b. For dispensing the standard sample, the terminal 330b is connected to an arm which movably supports the supply pump unit 330. In an exemplary configuration, the control circuitry 9 outputs to the drive mechanism 4 a control signal for establishing a connection between the standard sample container 300s, which is intended for the standard sample discharging operation, and the supply pump unit 330. According to this control signal, the drive mechanism 4 moves the arm that is movably supporting the supply pump unit 330 so that the pump head 330a of the supply pump unit 330 is connected to a top 325b of the container 325 in the standard sample container 300s. More specifically, the case 340 has an opening in its top, and the top 325b of the container 325 is exposed through the opening. Also, there is a through-hole in the exposed portion of the top 325b, and this through-hole is surrounded by an O-ring made of rubber, for example. The O-ring is covered or grasped by the pump head 330a, and the top 325b of the container 325 and the pump head 330a are thereby connected to each other.

Then, the control circuitry 9 in this example outputs to the drive mechanism 4 a control signal to cause the supply pump unit 330 to draw the medium for suctioning a predetermined amount of the standard sample from the container 321. According to the control signal, the drive mechanism 4 drives the supply pump unit 330 so that the supply pump unit 330 is controlled to draw the medium through the pump head 330a. In one example, the terminal 330b of the supply pump unit 330 includes a tube for providing a medium from the drive mechanism 4 to the standard sample container 300s via the arm, and for taking the medium from the standard sample container 300s to the drive mechanism 4 via the arm. The terminal 330b of the supply pump unit 330 also includes a signal line for controlling the supply pump unit 330 by use of the drive mechanism 4 via the arm. The drive mechanism 4, according to the control signal, controls the supply pump unit 330 via the signal line so that the medium is taken through the pump head 330a and the tube. Accordingly, by means of the supply pump unit 330, the medium is drawn through the end 322b of the cylinder 322 disposed in the container 325. The standard sample therefore flows into the cylinder 322 from the container 321 via the one-way valve 323.

Note that said predetermined amount of the standard sample may slightly exceed the amount set as an analysis parameter for the test item. In this case, when the standard sample flows into the cylinder 322 from the container 321 via the one-way valve 323, a small amount of the standard sample that has overflowed from the end 322b of the cylinder 322 is held in the container 325, while the cylinder 322 retains the amount of the inflow standard sample set as an analysis parameter for the test item. Here, in the container 325, since its bottom 325a is inclined, the flowing behavior of the standard sample toward the side face 321b of the container 321 is facilitated.

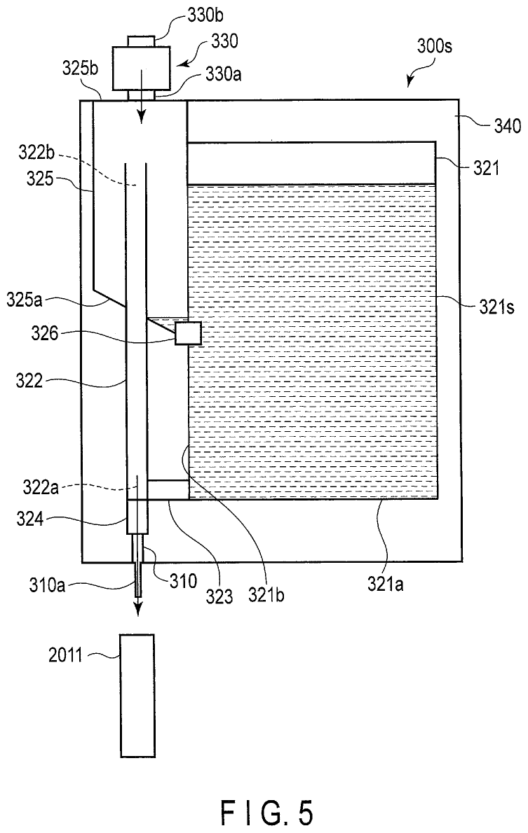

Then, the control circuitry 9 outputs to the drive mechanism 4 a control signal for ejecting the medium to the inside of the standard sample container 300s by the supply pump unit 330, for the discharge of the standard sample. According to this control signal, the drive mechanism 4 drives the supply pump unit 330 so that the supply pump unit 330 is controlled to eject the medium through the pump head 330a. For example, the drive mechanism 4, according to the control signal, controls the supply pump unit 330 via the signal line so that the medium is provided through the tube and the pump head 330a. Accordingly, by means of the supply pump unit 330, the medium is ejected through the end 322b of the cylinder 322 disposed in the container 325. Therefore, the standard sample retained in the cylinder 322 is discharged from the dispensing nozzle 310 via the one-way valve 324, as shown in FIG. 5. The drive mechanism 4 is one example of a driver for taking a medium from the discharging mechanism and providing the medium to the discharging mechanism. Also, the driver and the discharging mechanism constitute one example of a first dispenser for dispensing the standard sample kept in the reagent depository into the reaction tube.

With the electromagnetic valve 326, the overflow standard sample held in the container 325 can be recovered to the container 321. More specifically, the electromagnetic valve 326 includes a main component and a valve, and the control circuitry 9 outputs to the main component a control signal (e.g., a radio signal) for opening the valve. The main component opens the valve in response to the control signal output from the control circuitry 9. The standard sample accordingly flows into the container 321 from the container 325 via the electromagnetic valve 326.

In one example, once the dispensing action for the standard sample is completed, the control circuitry 9 outputs to the drive mechanism 4 a control signal for canceling the connection between the standard sample container 300s, from which the standard sample has been discharged, and the supply pump unit 330. According to this control signal, the drive mechanism 4 disconnects the pump head 330a of the supply pump unit 330 from the top 325b of the container 325 of the standard sample supply unit provided in the standard sample container 300s.

It is not required to recover the overflow standard sample from the container 325 to the container 321 every time the standard sample discharging operation is performed. For example, the recovery may be performed as an intermittent operation after conducting the standard sample discharging operation several times.

Also, since the standard sample is held in the container 325 of the standard sample container 300s only in a small amount, the recovery of the standard sample from the container 325 to the container 321 may be omitted. That is, the standard sample held in the container 325 may be discarded as long as its amount is very small. In this case, the electromagnetic valve 326 is unnecessary.

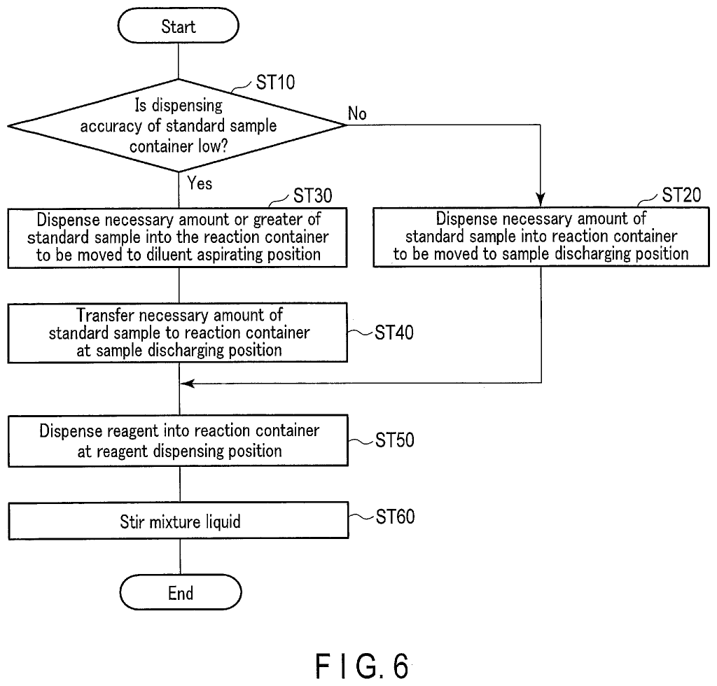

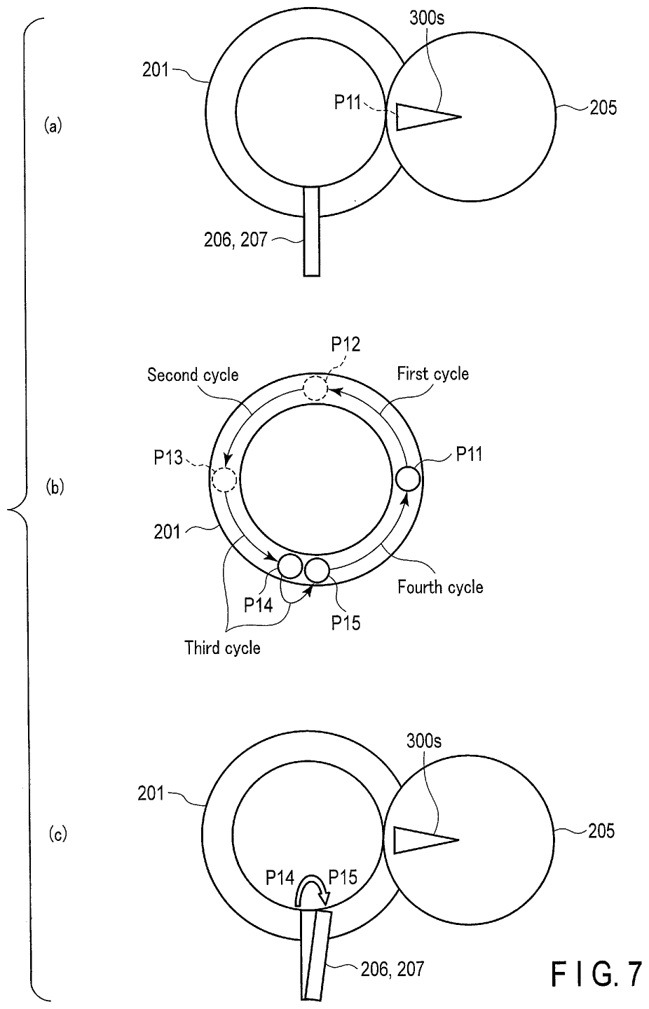

Next, exemplary operations with the standard sample container and the automatic analyzer having the above configurations will be described with reference to the flowchart in FIG. 6 and the schematic diagrams in FIG. 7. The exemplary operations relate to dispensing actions in the course of measurement conducted with the standard sample. The control circuitry 9 reads one or more control programs stored in the storage circuitry 8 at, for example, the activation of the automatic analyzer 1 to perform the system control function 91. With the system control function 91, the control circuitry 9 conducts processing for the dispensing actions during the activated state of the automatic analyzer 1.

The flowchart in FIG. 6 is associated with the description of concrete operations, given with reference to the schematic diagrams in FIG. 7. FIG. 7 sets forth schematic diagrams of the analysis mechanism 2 according to the first embodiment, seen from above.

Note that, in describing probe operations, etc. below, explanatory statements referring to the drive actions of the drive mechanism 4 for each component (such as “with the assistance of the drive mechanism 4” or “driven by the drive mechanism 4”) will be omitted. Also, unless otherwise stated, the description will assume that the control circuitry 9 controls each component for each operation. The subsequent flowcharts and their associated description will be given in a similar manner.

### Step ST10

The control circuitry 9 determines whether or not the standard sample container 300s provides a dispensing accuracy lower than a threshold value, and controls each component according to the determination so that either step ST20 or the set of steps ST30 to ST40 is performed next. Criteria for the dispensing accuracy being low or not are preset in the control programs. Note that the to-be-provided dispensing accuracy varies depends on the structure of each standard sample container 300s. Thus, the control circuitry 9 causes the supply pump unit 330 to operate in the same manner for the standard sample containers 300s regardless of the variety of the dispensing accuracy values. After the dispensing action, the control circuitry 9 controls each component so that a transferring action is not performed if the dispensing accuracy is high (step ST20), and the transferring action is performed if the dispensing accuracy is low (steps ST30 to ST40).

### Step ST20

If it is determined in step ST10 that the dispensing accuracy of the standard sample container 300S is not low, the control circuitry 9 causes the standard sample container 300s to dispense a necessary amount of the standard sample into the reaction container 2011 intended to be moved to the sample discharging position. More specifically, as shown in FIG. 7(a), the reaction disk 201 rotationally moves an empty reaction container 2011 to a reagent dispensing position (position P11) in advance. Meanwhile, inside the standard sample container 300s, the standard sample flows from the soft container 321s into the cylinder 322 via the one-way valve 323, in response to the operation of the supply pump unit 330. Then, the standard sample flows from the cylinder 322 via the one-way valve 324 and the dispensing nozzle 310 in response to the operation of the supply pump unit 330, so that the standard sample is discharged into the empty reaction container 2011 located at the reagent dispensing position. After the standard sample is dispensed, the reaction disk 201 rotationally moves the reaction container 2011 from the position P11 to the sample discharging position (position P15). During this rotational movement, the reaction disk 201 may let the reaction container 2011 make a stopover at positions P12 and P13 on its way from the position. P11 to the sample discharging position (position P15). Note that the sample discharging position may also be called a “subject sample discharging position”.

### Step ST30

If it is determined in step ST10 that the dispensing accuracy of the standard sample container 300S is low, the control circuitry 9 causes the standard sample container 300s to dispense an amount of the standard sample which is equal to or greater than the necessary amount into the reaction container 2011 intended to be moved to a diluent aspirating position. Here, an amount equal to or greater than the amount necessary for measurement is dispensed into the reaction tube because, when the transferring action is to be performed by the sample dispensing probe 207 as will be described, the sample dispensing probe 207 should aspirate the standard sample in an amount corresponding to the necessary amount plus a dummy amount. More specifically, as shown in FIG. 7(a), the reaction disk 201 rotationally moves an empty reaction container 2011 to the reagent dispensing position (position P11) in advance. Meanwhile, inside the standard sample container 300s, the standard sample flows from the soft container 321s into the cylinder 322 via the one-way valve 323, in response to the operation of the supply pump unit 330. Then, the standard sample flows from the cylinder 322 via the one-way valve 324 and the dispensing nozzle 310 in response to the operation of the supply pump unit 330, so that the standard sample is discharged into the empty reaction container 2011 located at the reagent dispensing position. After the standard sample is dispensed, the reaction disk 201 rotationally moves the reaction container 2011 from the position P11 to the diluent aspirating position (position P14) via the positions P12 and P13, as shown in FIG. 7(b). For example, this rotational movement may proceed from the position P11 to position P12 using the first cycle, position P12 to position P13 using the second cycle, and position P13 to position P14 using a portion of the third cycle.

### Step ST40

After step ST30, the control circuitry 9 conducts the transferring action where the standard sample is transferred to another empty reaction container 2011 as shown in FIG. 7(c). More specifically, the sample dispensing probe 207 aspirates the standard sample from the reaction container 2011 that has been moved to the position P14, and discharges the necessary amount of the standard sample among the aspirated standard sample into another reaction container 2011 located at the sample discharging position (position P15). Note that the combination of the aforementioned movement from the position P13 to position P14 and this transferring from the position P14 to position P15 may use the whole third cycle. The sample dispensing probe 207 is one example of a second dispenser for dispensing, after the first dispenser dispenses the standard sample into the reaction tube at the second position, the standard sample thus present in the reaction tube into another reaction tube. Such transferring from position P14 to position P15 is one example of an operation performed when a reaction tube containing the dispensed standard sample is moved to a position next to the first position, and this operation includes aspirating the standard sample from the reaction tube and discharging the standard sample into another reaction tube located at the first position.

### Step ST50

After step ST20 or ST40, the reaction disk 201 rotationally moves the reaction container 2011 containing the necessary amount of the standard sample from the position P15 to the reagent dispensing position (position P11). This movement may use the fourth cycle. The control circuitry 9 causes one reagent container 300 to dispense a given reagent into the reaction container 2011 that has been moved to the position. P11. Specifically, inside this reagent container 300, the reagent flows from the soft container 321s into the cylinder 322 via the one-way valve 323, in response to the operation of the supply pump unit 330. Then, the reagent flows from the cylinder 322 via the one-way valve 324 and the dispensing nozzle 310 in response to the operation of the supply pump unit 330, so that the reagent is discharged into the reaction container 2011 located at the reagent dispensing position. Such discharging is one example of an operation performed when another reaction tube containing the discharged standard sample, as mentioned above, is moved to the second position, and this operation includes dispensing a reagent into this another reaction tube at the second position. After the reagent is dispensed, the reaction disk 201 rotationally moves the reaction container 2011 containing the reagent and the standard sample from the position P11 to a mixture liquid stirring position (position P12).

### Step ST60

After step ST50, the control circuitry 9 conducts stirring of a mixture liquid of the reagent and the standard sample. More specifically, the stirring unit 215 is caused to stir, using a stirring tool, the mixture liquid present in the reaction container 2011 located at the mixture liquid stirring position (position P12).

After step ST60, the operation sequence is ended. Note that the control circuitry 9 may repeat the operations from step ST10 to step ST60 for each of, for example, the multiple standard sample containers 300s kept in the reagent depository 205.

As described above, a standard sample container according to the first embodiment includes a flexible soft container airtightly containing a standard sample for use in preparing a calibration curve or managing the accuracy for an automatic analyzer, a discharging mechanism for discharging the standard sample present in the soft container into a reaction container via a dispensing nozzle, and a chamber for accommodating the soft container. Therefore, since the standard sample for use in a test is taken from the airtight soft container, the quality degradation of the standard sample due to exposure to the outside air can be suppressed. Moreover, use of the standard sample container which airtightly seals the standard sample allows for the maintenance of the quality of the standard sample without requiring additional refrigerating equipment.

According to the first embodiment, the standard sample container may include a first valve and a second valve. The first valve is provided at the tip-side position in the discharging mechanism and serves to block a back-flow from a dispensing nozzle to the discharging mechanism. The second valve is provided at a position in the discharging mechanism which is closer to the soft container than the first valve, and serves to block a back-flow from the discharging mechanism to the inside of the soft container.

With these valves, occurrence of a back-flow can be prevented when causing the standard sample to flow from the soft container and be discharged via the discharging mechanism into the reaction container.

According to the first embodiment, the automatic analyzer may be provided with a reagent depository for keeping one or more standard sample containers adapted as described above and one or more reagent containers each containing a reagent. In this case, an automatic analyzer capable of realizing the discussed effects and advantages can be achieved.

According to the first embodiment, further, the automatic analyzer may include a sample dispensing probe adapted to independently dispense each of a sample and a standard sample. The sample dispensing probe may aspirate the standard sample from a first reaction container into which the standard sample has been dispensed from a standard sample container in an amount equal to or greater than a necessary amount, and, from the standard sample aspirated, discharge the necessary amount of the standard sample into a second reaction container. With this configuration, a dispensing action for the necessary amount of the standard sample can be secured even if the standard sample container provides a low dispensing accuracy.

### Second Embodiment

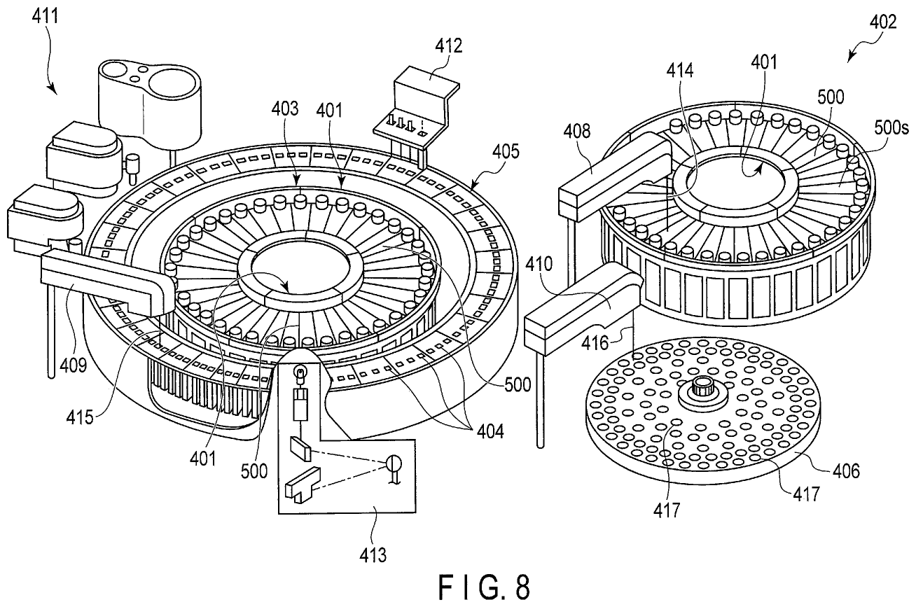

Next, a standard sample container and an automatic analyzer according to the second embodiment will be described with reference to FIGS. 8 to 10. The description will use the same reference symbol for the components or operational features of the same, or substantially the same, contents that appear in the already discussed drawings. The description will in principle omit details of such components, etc., and concentrate on portions differing from the foregoing embodiment. The subsequent embodiments will each be described in a similar manner, and redundant explanations will be omitted.

The second embodiment may be understood as a modification of the first embodiment and has a configuration where the location of the reagent depository is not above the reaction disk.

FIG. 8 is a schematic diagram of another exemplary design of the analysis mechanism 2 shown in FIG. 1. This analysis mechanism 2 includes: reagent containers 500 each containing a reagent such as a first reagent which selectively reacts with a subject sample for a given item or with a calibrator for the item, or a second reagent which is used with the first reagent in pairs; one or more standard sample containers 500s each airtightly containing a standard sample; reagent racks 401 each holding the reagent containers 500 and/or one or more standard sample containers 500s; a first reagent depository 402 enclosing one or more of the reagent racks 401 holding the reagent containers 500 each containing the first reagent and said one or more standard sample containers 500s; a second reagent depository 403 enclosing one or more of the reagent racks 401 holding the reagent containers 500 each containing the second reagent; a reaction disk 405 with multiple, circumferentially arranged reaction containers 404; and a disk sampler 406 set with subject sample containers 417 containing respective subject samples or calibrators. Note that said one or more standard sample containers 500s may be kept in either the first reagent depository 402 or the second reagent depository 403, or may be held in both of these depositories. By way of example, the description will assume an instance where said one or more standard sample containers 500s are kept only in the first reagent depository 402. The reaction disk 405 is another example of the rotary table. The first reagent depository 402 is one example of a reagent depository.

The first reagent depository 402, the second reagent depository 403, and the disk sampler 406 are each independently rotated at, for example, every one cycle, while the reaction disk 405 is rotated to stop at a given position under the control of the control circuitry 9.

The analysis mechanism 2 also includes a first reagent dispensing probe 414 and a second reagent dispensing probe 415 for aspirating the respective first and second reagents from the reagent containers 500 located at respective first and second reagent aspirating positions on the first and second reagent depositories 402 and 403, and for dispensing the respective first and second reagents into the reaction containers 404 stopped at respective first and second reagent dispensing positions, at every one cycle, for example. The analysis mechanism 2 further includes a sample dispensing probe 416 for aspirating the subject sample or the calibrator from the subject sample container 417 located at the position of the disk sampler 406 under the control of the control circuitry 9, and for dispensing the subject sample or the calibrator into the reaction container 404 stopped at a subject sample dispensing position, at every one cycle, for example.

Also, the analysis mechanism 2 includes a first reagent dispensing arm 408, a second reagent dispensing arm 409, and a dispensing arm 410 adapted to hold the first reagent dispensing probe 414, the second reagent dispensing probe 415, and the sample dispensing probe 416, respectively, in such a manner that these probes can pivot and vertically ascend and descend.

The analysis mechanism 2 further includes: a stirring unit 411 for stirring a mixture liquid in the reaction container 404 stopped at a stirring position at, for example, every one cycle; a photometry unit 413 for measuring this mixture liquid in the reaction container 404 from a photometry position at, for example, every one cycle; and a washing unit 412 for suctioning the measurement-completed mixture liquid from the reaction container 404 stopped at a washing and drying position, and also for washing and drying the inside of this reaction container 404, at, for example, every one cycle. Examples of the mixture liquid that can be suitably handled here include (i) a mixture liquid of the subject sample and the first reagent, (ii) a mixture liquid of the calibrator and the first reagent, (iii) a mixture liquid of the subject sample, the first reagent, and the second reagent, (iv) a mixture liquid of the calibrator, the first reagent, and the second reagent, and so on.

The photometry unit 413 measures changes in absorbency level of the mixture liquid by irradiating the rotationally moving reaction container 404 with light from the photometry position, and outputs analysis signals or calibration signals for the subject sample or the calibrator, obtained from the measurement, to the analysis circuitry 3. Upon being washed and dried after completion of the measurement of the associated mixture liquid, the reaction container 404 is again used for measurement.

In controlling each component in order to perform various measurement operations as discussed above, the control circuitry 9 controls corresponding mechanisms, etc., for rotating each of the first reagent depository 402, the second reagent depository 403, and the disk sampler 406, rotating the reaction disk 405, rotating and vertically moving each of the dispensing arm 410, the first reagent dispensing arm 408, the second reagent dispensing arm 409, and the stirring unit 411, and vertically moving the washing unit 412.

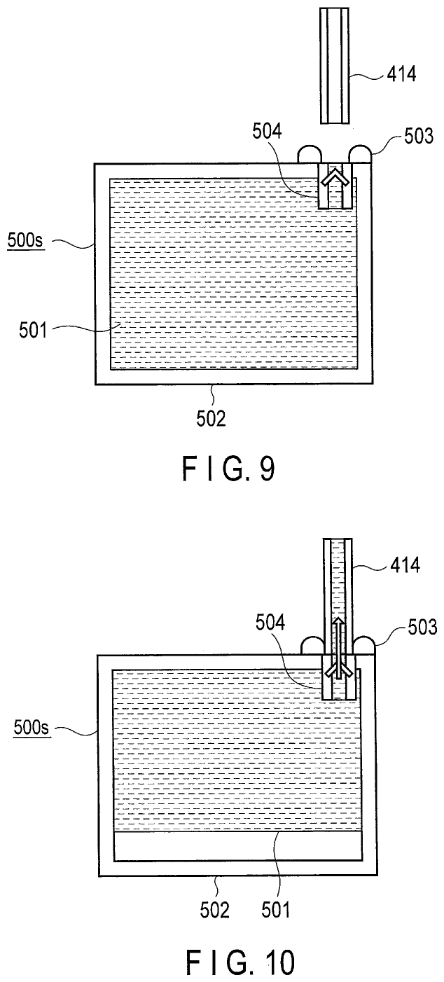

Next, an example of the standard sample container 500s for use with the automatic analyzer configured as above, as well as an example of the peripheral structure of the standard sample container 500s, will be described with reference to FIGS. 9 and 10.

The standard sample container 500s includes, as shown in FIGS. 9 and 10, a soft container 501, a housing 502, a probe connector 503, and a take-out part 504.

The soft container 501 is a flexible container for containing the standard sample, and is capable of airtightly keeping the standard sample. The soft container 501 may be formed of a material similar to that of the soft container 321s in the foregoing embodiment. The soft container 501 is enclosed in the housing 502 in such a manner that it is attached to the housing 502 via the probe connector 503 and the take-out part 504, while being penetrated by the take-out part 504.

The housing 502 encloses the soft container 501 in a non-airtight state. In one example, the housing 502 has an opening (not shown in the figure) to the outside air, which creates the non-airtight state of the housing 502. The housing 502 secures the probe connector 503 and the take-out part 504. The housing 502 may be formed of a material similar to that of the container 321, etc. in the foregoing embodiment.

The probe connector 503 is secured to a portion of the housing 502 and serves as a component to detachably connect the first reagent dispensing probe 414 to the take-out part 504.

The take-out part 504 is secured to another portion of the housing 502 and serves as a component to enable the first reagent dispensing probe 414 to aspirate the standard sample contained in the soft container 501. The take-out part 504 may include a valve for blocking a back-flow from the outside toward the inside of the soft container 501. The first reagent dispensing probe 414 is one example of a dispensing probe.

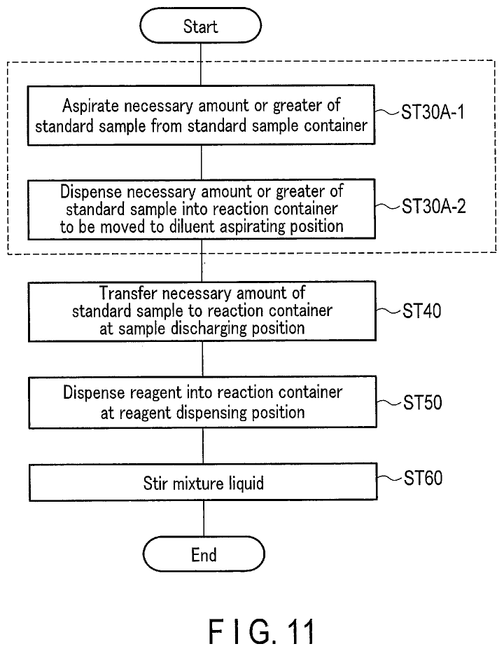

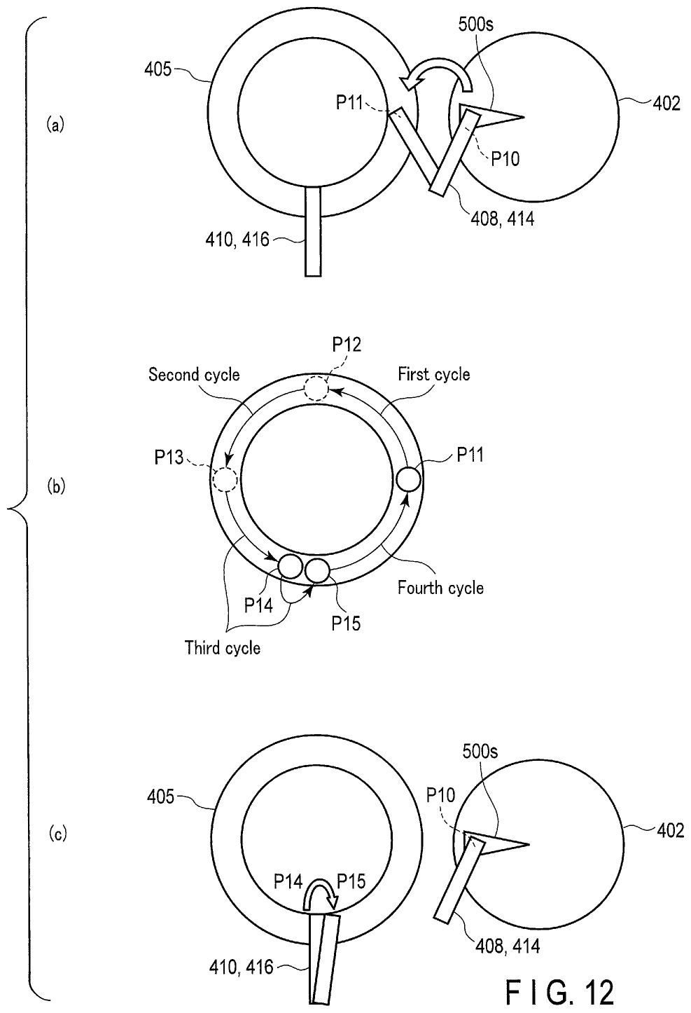

Next, exemplary operations with the standard sample container and the automatic analyzer having the above configurations will be described with reference to the flowchart in FIG. 11 and the schematic diagrams in FIG. 12. The exemplary operations relate to dispensing actions in the course of measurement conducted with the standard sample. The control circuitry 9 reads one or more control programs stored in the storage circuitry 8 at, for example, the activation of the automatic analyzer 1 to perform the system control function 91. With the system control function 91, the control circuitry 9 conducts processing for the dispensing actions during the activated state of the automatic analyzer 1.

The flowchart in FIG. 11 is associated with the description of concrete operations, given with reference to the schematic diagrams in FIG. 12. FIG. 12 sets forth schematic diagrams of the analysis mechanism 2 according to the second embodiment, seen from above. Note that the standard sample in the standard sample container 500s may be used without dilution, or may be diluted to a predetermined concentration by being discharged concurrently with water present in the first reagent dispensing probe 414 or a diluent that has been aspirated beforehand. To prepare calibration curves for multiple levels, standard samples of different concentrations need to be used. Providing all of such standard samples of different concentrations requires a large reagent depository for the storage of the respective standard sample containers 500s. As such, an efficient operation utilizes dilution of the standard sample to provide the standard samples of different concentrations for multiple levels. The description of the operations will start with steps ST30A-1 and ST30A-2, which correspond to step ST30 in the foregoing embodiment, in view of the circumstances that a typical reagent dispensing probe (the first reagent dispensing probe 414) does not provide a very high dispensing accuracy.

### Step ST30A-1

The control circuitry 9 performs control so that an amount of the standard sample which is equal to or greater than a necessary amount is dispensed from the standard sample container 500s into the reaction container 404 intended to be moved to a diluent aspirating position (steps ST30A-1 to ST30A-2). More specifically, as shown in FIG. 12(a), the reaction disk 405 rotationally moves an empty reaction container 404 to a reagent dispensing position (position P11) in advance. Meanwhile, the first reagent depository 402 rotationally moves the standard sample container 500s to a reagent aspirating position (position P10). The first reagent dispensing probe 414 aspirates the standard sample in an amount equal to or greater than the necessary amount from the standard sample container 500s at the position P10, and pivots from the position P10 to position P11 (the reagent dispensing position).

### Step ST30A-2

After step ST30A-1, the first reagent dispensing probe 414 discharges the aspirated standard sample, which is in the amount equal to or greater than the necessary amount, into the empty reaction container 404 at the reagent dispensing position (position P11). After the standard sample is dispensed, the reaction disk 405 rotationally moves the reaction container 404 from the position P11 to the diluent aspirating position (position P14) via positions P12 and P13, as shown in FIG. 12(b). For example, this rotational movement may proceed from the position P11 to position P12 using the first cycle, position P12 to position P13 using the second cycle, and position P13 to position P14 using a portion of the third cycle. The first reagent dispensing probe 414 here is another example of the first dispenser for dispensing the standard sample kept in the reagent depository into a reaction tube.

### Step ST40

After step ST30A-1 to ST30A-2, the control circuitry 9 conducts a transferring action where the standard sample is transferred to another empty reaction container 404 as shown in FIG. 12(c). More specifically, the sample dispensing probe 416 aspirates the standard sample from the reaction container 404 that has been moved to the position. P14, and discharges the necessary amount of the standard sample among the aspirated standard sample into another reaction container 404 located at a sample discharging position (position P15). Note that the combination of the aforementioned movement from the position P13 to position P14 and this transferring from the position P14 to position P15 may use the whole third cycle. The sample dispensing probe 416 is another example of the second dispenser for dispensing, after the first dispenser dispenses the standard sample into the reaction tube at the second position, the standard sample thus present in the reaction tube into another reaction tube.

### Step ST50

After step ST40, the reaction disk 405 rotationally moves the reaction container 404 containing the necessary amount of the standard sample from the position P15 to the reagent dispensing position (position P11). This movement may use the fourth cycle. The control circuitry 9 performs control so that a given reagent is dispensed from one reagent container 500 into the reaction container 404 that has been moved to the position P11. More specifically, the first reagent dispensing probe 414 aspirates the reagent from the reagent container 500 at the position P10, and pivots from the position P10 to position P11 (the reagent dispensing position) to discharge the reagent to the reaction container 404 there. After the reagent is dispensed, the reaction disk 405 rotationally moves the reaction container 404 containing the reagent and the standard sample from the position P11 to a mixture liquid stirring position (position P12).

### Step ST60

After step ST50, the control circuitry 9 conducts stirring of a mixture liquid of the reagent and the standard sample. More specifically, the stirring unit 215 is caused to stir, using a stirring tool, the mixture liquid present in the reaction container 404 located at the mixture liquid stirring position (position P12).

After step ST60, the operation sequence is ended. Note that the control circuitry 9 may repeat the operations from step ST30A-1 to step ST60 for each of, for example, the multiple standard sample containers 500s kept in the first reagent depository 402.

As described above, a standard sample container according to the second embodiment includes a flexible soft container airtightly containing a standard sample, a housing enclosing the soft container in a non-airtight state, and a take-out part secured to a portion of the housing and adapted to enable a reagent dispensing probe (or a sample dispensing probe) to aspirate the standard sample contained in the soft container. Here, the standard sample for use in a test is taken from the airtight soft container, and therefore, the quality degradation of the standard sample due to exposure to the outside air can be suppressed.

Also, according to the second embodiment, the take-out part of the standard sample container may include a valve for blocking a back-flow from the outside toward the inside of the soft container. This can prevent a contaminant, etc. from entering the soft container.

According to the second embodiment, the automatic analyzer may be provided with a reagent depository for keeping one or more standard sample containers adapted as described above and one or more reagent containers each containing a reagent. In this case, an automatic analyzer capable of realizing the discussed effects and advantages can be achieved.

According to the second embodiment, further, the automatic analyzer may include a reagent dispensing probe adapted to independently dispense each of a reagent and a standard sample. For dispensing the standard sample, the reagent dispensing probe may aspirate the standard sample through the take-out part, and discharge the aspirated standard sample into a reaction container. This can eliminate the necessity of providing a standard sample dispensing probe in addition to providing a reagent dispensing probe, and therefore, the configurations can be simplified.

### Third Embodiment

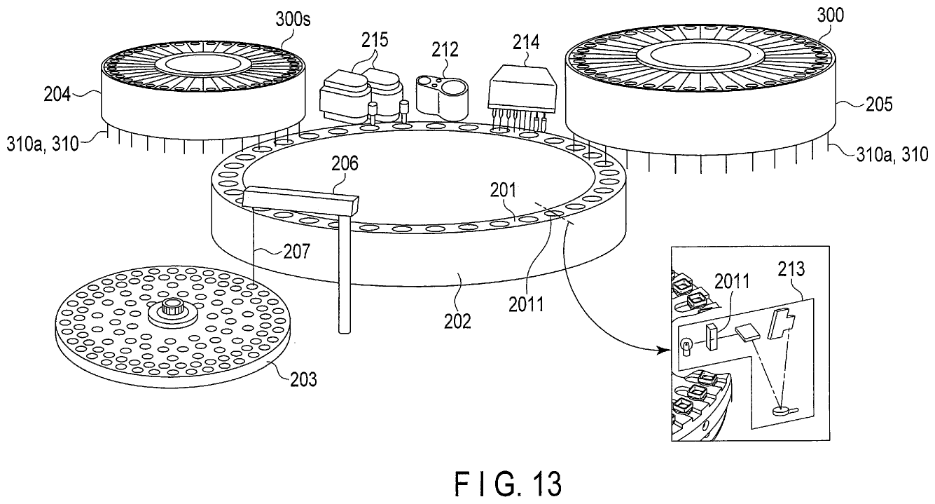

Next, a standard sample container and an automatic analyzer according to the third embodiment will be described with reference to FIG. 13. An exemplary design of the automatic analyzer is shown obliquely in FIG. 13.

The third embodiment may be understood as a modification of the first embodiment and uses configurations including a standard sample depository 204 which is adapted to keep, among standard sample containers 300s and reagent containers 300, only the standard sample containers 300s.

The remaining aspects may be the same as the first embodiment.

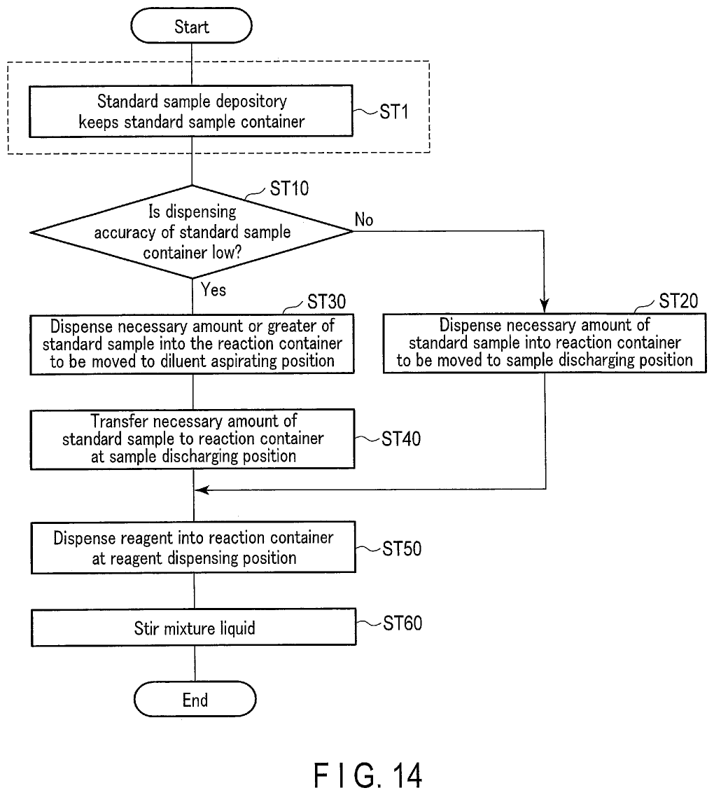

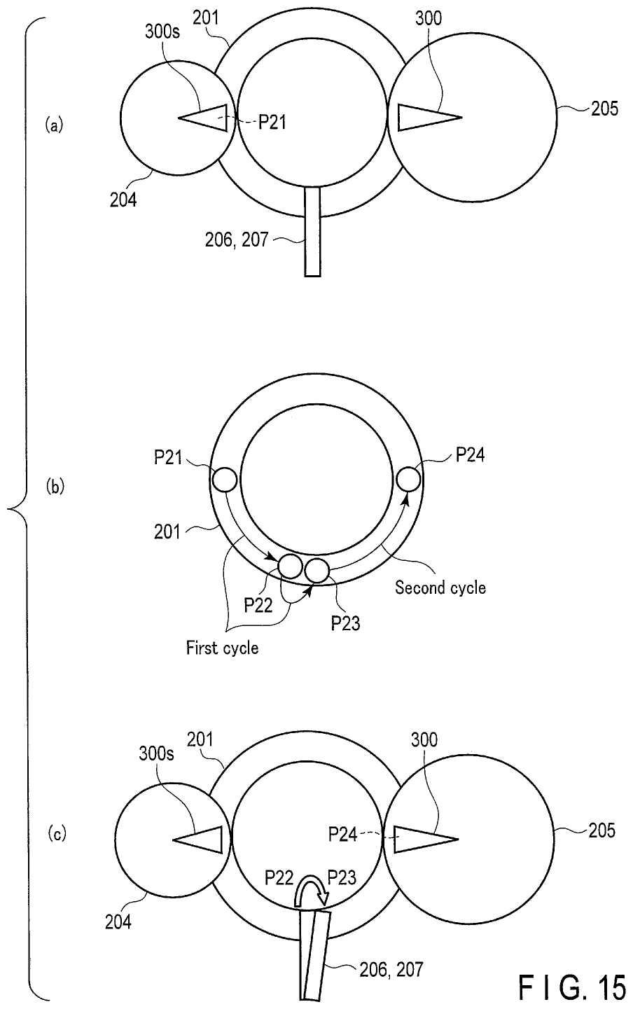

Next, exemplary operations with the standard sample container and the automatic analyzer having such configurations will be described with reference to the flowchart in FIG. 14 and the schematic diagrams in FIG. 15. For these exemplary operations, the description will use positions P21 to P24, instead of referring to the positions P11 to P15 as used in the foregoing embodiments, in view of the configurations with the standard sample depository 204.

### Step ST1

First, before measurement with a standard sample, each standard sample container 300s is set in the standard sample depository 204. Accordingly, the standard sample depository 204 keeps the standard sample containers 300s.

### Step ST10

Step ST10 proceeds in the same manner as in the foregoing embodiment.

### Step ST20

If it is determined in step ST10 that the dispensing accuracy of the standard sample container 3005 is not low, the control circuitry 9 causes the standard sample container 300s to dispense a necessary amount of the standard sample into the reaction container 2011 intended to be moved to a sample discharging position. More specifically, as shown in FIG. 15(a), the reaction disk 201 rotationally moves an empty reaction container 2011 to a standard sample dispensing position (position P21) in advance. The standard sample container 300s discharges the standard sample into the empty reaction container 2011 located at this standard sample dispensing position, according to the operation of the supply pump unit 330. After the standard sample is dispensed, the reaction disk 201 rotationally moves the reaction container 2011 from the position P21 to the sample discharging position (position P23).

### Step ST30

If it is determined in step ST10 that the dispensing accuracy of the standard sample container 300S is low, the control circuitry 9 causes the standard sample container 300s to dispense an amount of the standard sample which is equal to or greater than the necessary amount into the reaction container 2011 intended to be moved to a diluent aspirating position. More specifically, as shown in FIG. 15(a), the reaction disk 201 rotationally moves an empty reaction container 2011 to the standard sample dispensing position (position P21) in advance. The standard sample container 300s discharges the standard sample into the empty reaction container 2011 located at this standard sample dispensing position, according to the operation of the supply pump unit 330. After the standard sample is dispensed, the reaction disk 201 rotationally moves the reaction container 2011 from the position P21 to the diluent aspirating position (position P22) as shown in FIG. 12(b). For example, this movement from the position P21 to P22 may use a portion of the first cycle.

### Step ST40

After step ST30, the control circuitry 9 conducts a transferring action where the standard sample is transferred to another empty reaction container 2011 as shown in FIG. 15(c). More specifically, the sample dispensing probe 207 aspirates the standard sample from the reaction container 2011 that has been moved to the position P22, and discharges the necessary amount of the standard sample among the aspirated standard sample into another reaction container 2011 located at the sample discharging position (position P23). Note that the combination of the aforementioned movement from the position P21 to position P22 and this transferring from the position P22 to position P23 may use the whole first cycle.

### Step ST50

After step ST20 or ST40, the reaction disk 201 rotationally moves the reaction container 2011 containing the necessary amount of the standard sample from the position P23 to a reagent dispensing position (position P24). This movement may use the second cycle. The control circuitry 9 causes one reagent container 300 to dispense a given reagent into the reaction container 2011 that has been moved to the position P24. More specifically, the reagent container 300 discharges the reagent into the reaction container 2011 located at the reagent dispensing position, according to the operation of the supply pump unit 330. After the reagent is dispensed, the reaction disk 201 rotationally moves the reaction container 2011 containing the reagent and the standard sample from the position P24 to a mixture liquid stirring position (not shown in the figure).

### Step ST60

After step ST50, step ST10 proceeds in the same manner as in the foregoing embodiments.

After step ST60, the operation sequence is ended. Note that the control circuitry 9 may repeat the operations from step ST10 to step ST60 for each of, for example, the multiple standard sample containers 300s kept in the standard sample depository 204.

As described above, an automatic analyzer according to the third embodiment includes a standard sample depository adapted to keep, among standard sample containers and reagent containers, only the standard sample containers. Accordingly, the third embodiment can realize the advantage of reducing the cycle numbers required for operations from the standard sample dispensing action to the reagent dispensing action, in addition to realizing the same advantages as those of the first embodiment.

Supposing that a reagent depository for keeping both the standard sample containers and the reagent containers is used, the standard sample dispensing position conforms to the reagent dispensing position. In this case, the reaction disk that carries a reaction container for containing a dispensed standard sample makes a full rotation for the operations from the standard sample dispensing action to the reagent dispensing action, whereby the reaction container returns to the standard sample dispensing position (which conforms to the reagent dispensing position). Here, the full rotation of the reaction disk correspond to, for example, four cycles.

In contrast, use of separate depositories, i.e., a standard sample depository for keeping the standard sample containers and a reagent depository for keeping the reagent containers, allows for the setting of a standard sample dispensing position and a reagent dispensing position differing from each other. Accordingly, the reaction disk that carries a reaction container for containing a dispensed standard sample makes about a half rotation for the operations from the standard sample dispensing action to the reagent dispensing action, whereby the reaction container reaches the reagent dispensing position. The half rotation of the reaction disk corresponds to, for example, two cycles. Accordingly, the third embodiment can reduce the cycle numbers required for operations from the standard sample dispensing action to the reagent dispensing action.

Note that the concept and configuration of the third embodiment are applicable not only to the first embodiment but also to the second embodiment. When they are applied to the second embodiment, the standard sample depository may adopt the configuration of the first reagent depository 402 or the configuration of the standard sample depository 204 described above. In any case, the second embodiment applied with the concept and configuration of the third embodiment can realize the advantage of reducing the cycle numbers required for operations from the standard sample dispensing action to the reagent dispensing action, in addition to realizing the same advantages as those of the second embodiment.

### Fourth Embodiment

Next, a standard sample container and an automatic analyzer according to the fourth embodiment will be described.

The fourth embodiment may be understood as a modification of the second embodiment and uses configurations including a disk sampler 406 adapted to hold subject sample containers 417 each containing a subject sample (or simply “a sample”), and one or more standard sample containers 417s. Note that this disk sampler 406 is not required to be the new component, but may be the disk sampler 406 as in the second embodiment which holds one or more standard sample containers 417s in addition to the subject sample containers 417.

Each standard sample container 417s has, for example, a shape of a test tube similar to the subject sample container 417 but is adapted to, unlike the subject sample container 417, airtightly contain a given standard sample. More specifically, and for example, each standard sample container 417s may be a combination of one empty subject sample container 417 with an internally disposed soft container that airtightly contains the standard sample. As one concrete example, the standard sample container 417s has a structure similar to that of the standard sample container 500s shown in FIGS. 9 and 10, but is reshaped into a test tube. In such an example, the housing 502 is formed to have a test tube shape similar to the subject sample container 417. The standard sample container 417s thus includes, similar to the standard sample container 500s, its own soft container 501, housing 502, probe connector 503, and take-out part 504. For these configurations, the sample dispensing probe 416 is adapted to independently dispense each of a sample and a standard sample. For dispensing the standard sample, the sample dispensing probe 416 aspirates the standard sample through the take-out part 504 of the standard sample container 417s, and discharges the aspirated standard sample into one of the reaction containers 404.

The remaining aspects may be the same as the second embodiment.

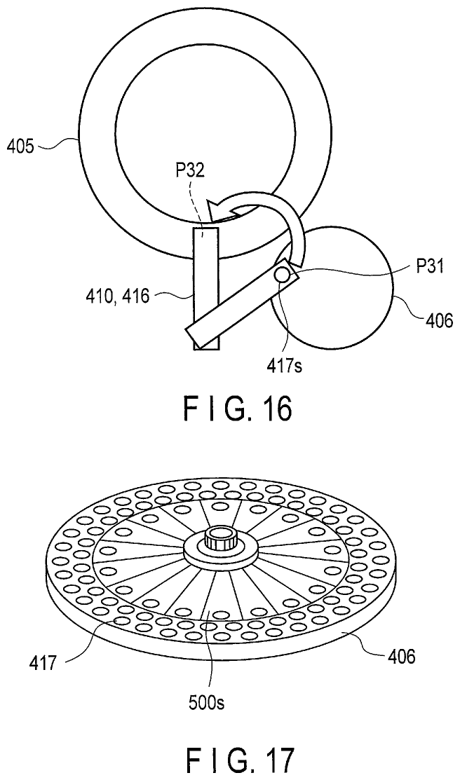

With these configurations, the sample dispensing probe 416 aspirates the standard sample from the standard sample container 417s located at a sample aspirating position (position P31) on the disk sampler 406 as shown in FIG. 16. The sample dispensing probe 416 then discharges a necessary amount of the standard sample among the aspirated standard sample into the reaction container 404 located at a sample discharging position (position P32) on the reaction disk 405. In this manner, the standard sample present in the standard sample container 417s is dispensed into the reaction container 404.

Subsequently, the automatic analyzer 1 performs the processes of step ST50 and onward as in the foregoing embodiments.

As described above, the configurations according to the fourth embodiment include a sampler for holding sample containers each containing a sample, and one or more standard sample containers. The configurations also include a sample dispensing probe adapted to independently dispense each of the sample and a standard sample. For dispensing the standard sample, the sample dispensing probe aspirates the standard sample from the standard sample container through its take-out part, and discharges the aspirated standard sample into a reaction container. Thus, since the sampler keeps the standard sample containers, the fourth embodiment can realize the standard sample dispensing action at the same level as the sample dispensing action, in addition to realizing the same advantages as those of the second embodiment.

### Modification of Fourth Embodiment

The fourth embodiment may be modified as shown in FIG. 17.

This modification of the fourth embodiment employs a disk sampler 406 which is adapted to hold the subject sample containers 417 in the outer circumferential portion and the standard sample containers 500s in the inner circumferential portion. The standard sample containers 500s held in the inner circumferential portion each have the same structure as shown in FIGS. 9 and 10. The remaining aspects are the same as the fourth embodiment.

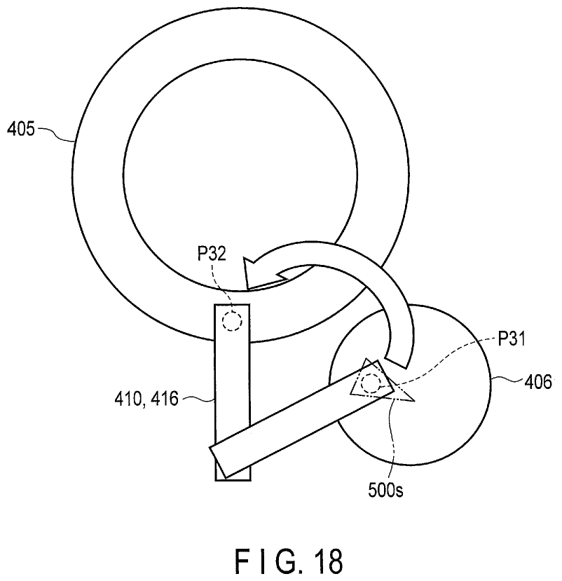

With these configurations, the sample dispensing probe 416 aspirates the standard sample from the standard sample container 500s located at a sample aspirating position (position P31) on the disk sampler 406 as shown in FIG. 18. The sample dispensing probe 416 then discharges a necessary amount of the standard sample among the aspirated standard sample into the reaction container 404 located at a sample discharging position (position P32) on the reaction disk 405. In this manner, the standard sample present in the standard sample container 500s is dispensed into the reaction container 404.

Subsequently, the automatic analyzer 1 performs the processes of step ST50 and onward as in the foregoing embodiments.

The modification as above can also provide the same effects and advantages as described for the fourth embodiment.

### Fifth Embodiment

Next, an automatic analyzer according to the fifth embodiment will be described. The concept and configuration of the fifth embodiment which will be described below are applicable to all the first to fourth embodiments, but in order to facilitate understanding, the description will assume an exemplary instance where they are applied to the first embodiment. For application to the other embodiments, the reference symbols, etc. in the description may be replaced as appropriate.

The fifth embodiment may be understood as a concrete example of any of the first to fourth embodiments, and it relates to processes where the measurement with a standard sample is performed as a calibration measurement.

Accordingly, the control circuitry 9 with the calibration decision function 92 decides whether or not a calibration measurement is necessary based on, for example, at least one of the expiry date/time of the reagent, the remaining amount of the reagent, or the expiry date/time of the calibration curve. If a calibration measurement is found to be necessary, the control circuitry 9 with the system control function 91 controls each component in the automatic analyzer 1 so that the calibration measurement is performed.

The remaining aspects may be the same as the first embodiment.

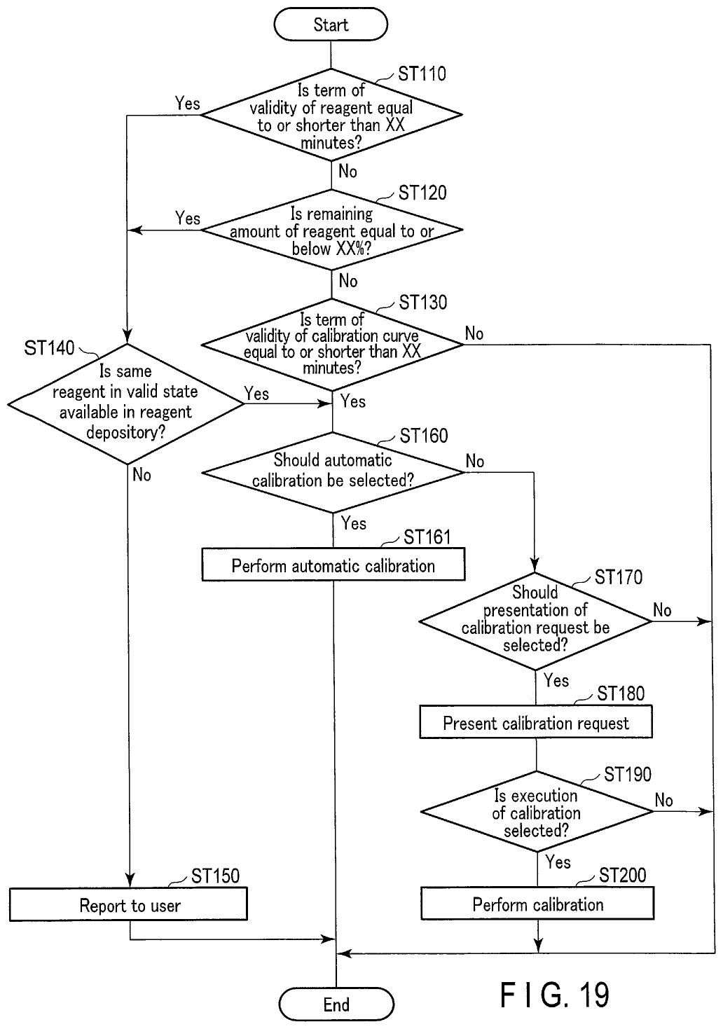

Next, with reference to the flowchart in FIG. 19, a description will be given of exemplary operations of the automatic analyzer 1 configured as above which are performed in association with a calibration measurement. An outline of the operations is as follows. A reagent used in measurement is checked for its expiry date/time (term of validity) and remaining amount (steps ST110 to ST120). If the reagent is expired or if it is a predetermined time before expiry, or if the reagent is consumed or about to be consumed, a reagent depository is checked to see if it keeps the same reagent in a valid state (step ST140). If the same reagent in a valid state is available in the reagent depository, a status regarding an automatic calibration for the corresponding item is confirmed (step ST160), and where appropriate, a status regarding presentation of a calibration request is confirmed (step ST170). If the automatic calibration status is active, an automatic calibration is performed (step ST161). If the calibration request presentation status is active, a user is given a calibration request (step ST180). If the user selects execution of calibration, a calibration is performed (steps ST190 to ST200). If the reagent is valid and a sufficient amount remains, a calibration curve is checked for its expiry date/time (step ST130). If the calibration curve is expired or if it is a predetermined time before expiry, a status regarding an automatic calibration for the corresponding item is confirmed (step ST160), and where appropriate, a status regarding presentation of a calibration request is confirmed (step ST170). The subsequent operations proceed in a manner similar to the case where the same reagent in a valid state is available.

The length of the predetermined time before expiry of the reagent, as well as that of the calibration curve, may be discretionarily set by the user, etc., or may be fixed to a given time period, e.g., one hour to the expiry. The amount of the reagent that will result in the reagent being considered to be about to be consumed may be discretionarily set by the user, etc., or may be fixed to a given amount, e.g., 3% of the total amount (as a remaining amount). When a fresh calibration curve is prepared, the operations may immediately transition to the use of the next reagent and validate this fresh calibration curve, or may withhold it until the current reagent is consumed. Also, the operations may adopt a mode of performing the automatic calibration in response to an introduction of the corresponding item to the measurement items for a subject, in addition to the triggers based on the remaining amount of the reagent, the expiry of the reagent and/or the calibration curve, and so on.

The outline of the exemplary operations performed in association with a calibration measurement has been given. The details of the exemplary operations will be explained next, with reference to the flowchart in FIG. 19.

### Step ST110

The control circuitry 9 determines whether or not the term of validity of the reagent is equal to or below a threshold. If the term is determined to be equal to or below the threshold, the operation flow advances to step ST140. If not, the operation flow advances to step ST120.

### Step ST120

After step ST110, the control circuitry 9 determines whether or not the remaining amount of the reagent is equal to or below a threshold. If the remaining amount is determined to be equal to or below the threshold, the operation flow advances to step ST140. If not, the operation flow advances to step ST130.

### Step ST130

After step ST120, the control circuitry 9 determines whether or not the term of validity of the calibration curve is equal to or below a threshold. If the term is determined to be equal to or below the threshold, the operation flow advances to step ST160. If not, the operation is terminated. Note that what should be determined in steps ST110 to ST130 (i.e., in this example, the term of validity of the reagent, the remaining amount of the reagent, and the term of validity of the calibration curve) may be discretionarily transposed or reversed, or these determination steps may be omitted if at least one of them is maintained.

### Step ST140

After step ST110 or ST120, the control circuitry 9 determines whether or not the same reagent in a valid state is available in the reagent depository 205. If it is determined that the same reagent in a valid state is available, the operation flow advances to step ST160. If not, the operation flow advances to step ST150. This determination may be based on, for example, a process of reading a barcode (not shown in the figures) on each reagent container kept in the reagent depository 205, or based on reagent information indicative of the reagents kept in the reagent depository 205. Such reagent information may be prestored in the storage circuitry 8.

### Step ST150

After step ST140, the control circuitry 9 reports to the user, etc. via the output interface 6 that the same reagent in a valid state is absent from the reagent depository 205. The operation is then terminated.

### Step ST160

After step ST130 or ST140, the control circuitry 9 determines whether or not an automatic calibration should be selected based on preset selection information. If it is determined that the automatic calibration should be selected, the operation flow advances to step ST161. If not, the operation flow advances to step ST170.

### Step ST161

After step ST160, the control circuitry 9 controls each component so that the automatic calibration is performed. Automatic calibration here refers to a calibration measurement performed without an instruction from the user, etc. Additionally, with a configuration capable of recognizing the standard sample containers 300s, etc. via the respective barcodes attached thereto, it is possible to prevent occurrence of errors in calibration curves due to the calibration measurement being performed using a wrong standard sample or due to the containers being set in a wrong order. After performing the automatic calibration, the operation is terminated.

### Step ST170

After step ST160, the control circuitry 9 determines whether or not presentation of a calibration request should be selected based on the preset selection information. If it is determined that presentation of a calibration request should be selected, the operation flow advances to step ST180. If not, the operation is terminated.

### Step ST180

After step ST170, the control circuitry 9 controls the output interface 6 to present a calibration request. The output interface 6 may accordingly display a calibration request which prompts selecting the execution of calibration.

### Step ST190

During the presentation of a calibration request according to step ST180, the control circuitry 9 determines whether or not the execution of calibration is selected. If it is determined that the execution of calibration is selected, the operation flow advances to step ST200. If not, the operation is terminated.

### Step ST200

After step ST190, the control circuitry 9 controls each component so that the calibration is performed. The calibration in step ST200 refers to a calibration measurement performed in response to a selection operation from the user, etc. After performing the calibration, the operation is terminated.

As described above, according to the fifth embodiment where the measurement using a standard sample is performed as a calibration measurement, the decider decides whether or not the calibration measurement is necessary based on at least one of the expiry date/time of the reagent, the remaining amount of the reagent, or the expiry date/time of the calibration curve. Therefore, the fifth embodiment can realize the advantage of enabling a calibration measurement to be performed either automatically or at the operation of a user, etc., once the calibration measurement becomes necessary, in addition to realizing the same advantages as those of the first to fourth embodiments to which the fifth embodiment is applied.

As another perspective, the embodiment eliminates the need for the user, etc. to prepare new standard samples at the expiry of the calibration curve. Also, the configuration of conducting calibration before the expiry can avoid the occurrence of an event where the measurement for a subject is not permitted during the preparation of a fresh calibration curve. Additionally, with the configuration of recognizing the standard sample containers by means of barcodes, etc., it is possible to prevent the occurrence of errors in calibration curves due to the calibration measurement being performed using a wrong standard sample or due to the containers being set in a wrong order.

### Sixth Embodiment

An automatic analyzer according to the sixth embodiment will be described. The concept and configuration of the sixth embodiment which will be described below are applicable to all the first to fifth embodiments, but in order to facilitate understanding, the description will assume an exemplary instance where they are applied to the first embodiment. For application to the other embodiments, the reference symbols, etc. in the description may be replaced as appropriate.

The sixth embodiment may be understood as a concrete example of any of the first to fifth embodiments, and it relates to processes where the measurement with a standard sample is performed as a fresh controlled measurement.

Accordingly, the control circuitry 9 with the controlled-measurement decision function 93 decides whether or not a fresh controlled measurement is necessary based on, for example, at least one of the presence or absence of a freshly prepared calibration curve, or the time elapsed since the previous controlled measurement. If a fresh controlled measurement is found to be necessary, the control circuitry 9 with the system control function 91 controls each component in the automatic analyzer 1 so that a fresh controlled measurement is performed.

The remaining aspects may be the same as the first embodiment.

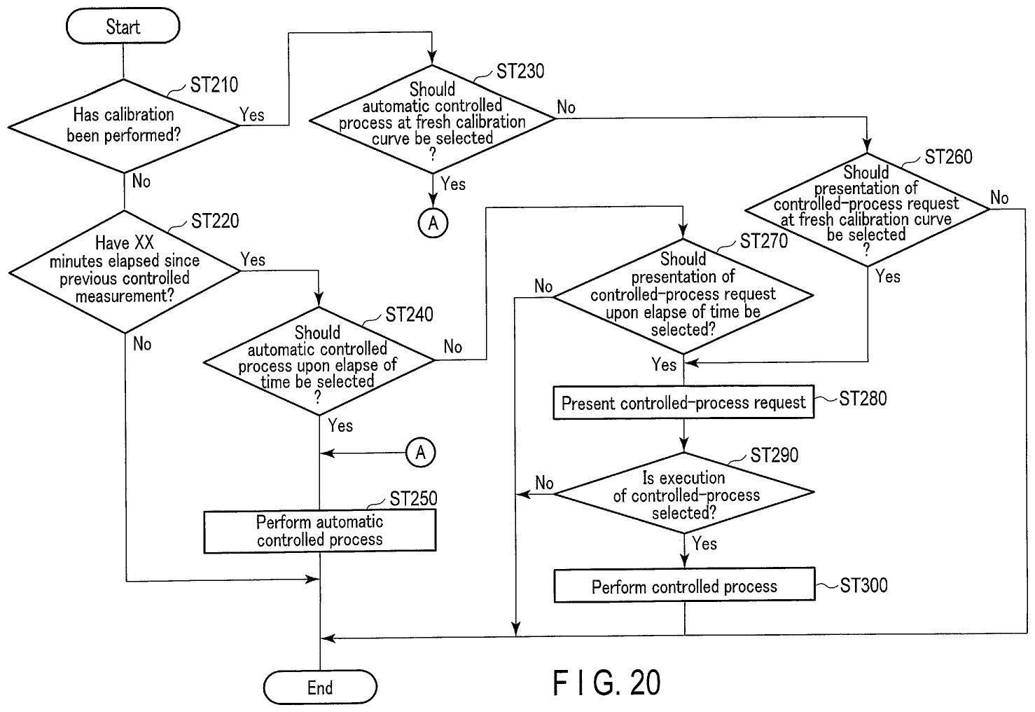

Next, with reference to the flowchart in FIG. 20, a description will be given of exemplary operations of the automatic analyzer 1 configured as above which are performed in association with a controlled measurement.

An outline of the operations is as follows. When a calibration measurement is performed and the fresh calibration curve is prepared (step ST210), a status regarding an automatic controlled process for the corresponding item is confirmed (step ST230), and where appropriate, a status regarding presentation of a controlled-process request is confirmed (step ST260). If the automatic controlled-process status is active, an automatic controlled process is performed (step ST250). If the controlled-process request presentation status is active, a user is given a controlled-process request (step ST280). If the user selects execution of a controlled process, the controlled process is performed (steps ST290 to ST300). When a predetermined time has elapsed since the previous controlled process (step ST220), a status regarding an automatic controlled process for the corresponding item is confirmed (step ST240), and where appropriate, a status regarding presentation of a controlled-process request is confirmed (step ST270). The subsequent operations proceed in a manner similar to the case where the fresh calibration curve is prepared.

The length of the predetermined time, as a time elapsed since the previous controlled process, may be discretionarily set by the user, etc., or may be fixed to a given time period, e.g., five hours. Also, the operations may adopt a mode of performing the automatic controlled process in response to an activation of the system (upon auto-startup actions), in addition to the triggers based on a freshly prepared calibration curve, elapse of a predetermined time, and so on.

The outline of the exemplary operations performed in association with a controlled measurement has been given. The details of the exemplary operations will be explained next, with reference to the flowchart in FIG. 20.

### Step ST210

The control circuitry 9 determines whether or not a calibration measurement has been freshly performed. If it is determined that a fresh calibration measurement has been performed, the operation flow advances to step ST230. If not, the operation flow advances to step ST220. Note that the determination contents in step ST210 are synonymous with the determination as to whether or not a fresh calibration curve has been prepared.

### Step ST220

After step ST210, the control circuitry 9 determines whether or not a predetermined time has elapsed since the previous controlled measurement. If it is determined that the predetermined time has elapsed, the operation flow advances to step ST240. If not, the operation is terminated.

### Step ST230

After step ST210, the control circuitry 9 determines, based on preset selection information, whether or not an automatic controlled process at the preparation of the fresh calibration curve should be selected. If it is determined that the automatic controlled process for this instance should be selected, the operation flow advances to step ST250. If not, the operation flow advances to step ST260.

### Step ST240

After step ST220, the control circuitry 9 determines, based on the preset selection information, whether or not an automatic controlled process upon elapse of the predetermined time should be selected. If it is determined that the automatic controlled process for this instance should be selected, the operation flow advances to step ST250. If not, the operation flow advances to step ST270.

### Step ST250

After step ST230 or ST240, the control circuitry 9 controls each component so that the automatic controlled process is performed. The automatic controlled process here refers to a controlled measurement performed without an instruction from the user, etc. After performing the automatic controlled process, the operation is terminated.

### Step ST260

After step ST230, the control circuitry 9 determines, based on the preset selection information, whether or not presentation of a controlled-process request at the preparation of the fresh calibration curve should be selected. If it is determined that presentation of a controlled-process request for this instance should be selected, the operation flow advances to step ST280. If not, the operation is terminated.

### Step ST270

After step ST240, the control circuitry 9 determines, based on the preset selection information, whether or not presentation of a controlled-process request upon elapse of the predetermined time should be selected. If it is determined that presentation of a controlled-process request for this instance should be selected, the operation flow advances to step ST280. If not, the operation is terminated.

### Step ST280

After step ST260 or ST270, the control circuitry 9 controls the output interface 6 to present a controlled-process request. The output interface 6 may accordingly display a controlled-process request which prompts selecting the execution of a controlled process.

### Step ST290

During the presentation of a controlled-process request according to step ST280, the control circuitry 9 determines whether or not the execution of a controlled-process is selected. If it is determined that the execution of a controlled-process is selected, the operation flow advances to step ST300. If not, the operation is terminated.

### Step ST300

After step ST290, the control circuitry 9 controls each component so that the controlled process is performed. The controlled process in step ST300 refers to a controlled measurement performed in response to a selection operation from the user, etc. After performing the controlled measurement, the operation is terminated.

As described above, according to the sixth embodiment where the measurement using a standard sample is performed as a fresh controlled measurement, the decider decides whether or not a fresh controlled measurement is necessary based on at least one of the presence or absence of a freshly prepared calibration curve, or the time elapsed since the previous controlled measurement. Therefore, the sixth embodiment can realize the advantage of enabling a controlled measurement to be performed either automatically or at the operation of a user, etc. once a fresh controlled measurement becomes necessary, in addition to realizing the same advantages as those of the first to fifth embodiments to which the sixth embodiment is applied. Also, as in the foregoing embodiments, the configuration of conducting calibration and controlled measurement before the expiry of the reagents or the calibration curves makes it possible to avoid the occurrence of an event where the measurement for a subject is not permitted during the preparation of a fresh calibration curve.

According to at least one foregoing embodiment, the quality degradation of the standard sample can be suppressed.

The terminology “processor” used herein refers to, for example, a central processing unit (CPU) or a graphics processing unit (GPU), or various types of circuitry which may be an application-specific integrated circuit (ASIC), a programmable logic device (such as a simple programmable logic device (SPLD), a complex programmable logic device (CPLD), or a field programmable gate array (FPGA)), and so on. The processor reads programs stored in storage circuitry and executes them to realize the intended functions. The programs may be incorporated in the circuit of the processor, instead of being stored in the storage circuit. In this case, the processor reads the programs incorporated in its circuit and executes them to realize the functions. The embodiments herein do not limit each processor to a single circuitry-type processor. Multiple independent circuits may be combined and integrated as one processor to realize the intended functions. Furthermore, multiple components or features as given in FIG. 1 may be integrated as one processor to realize their respective functions.

Note that the standard sample containers and the automatic analyzers as described above may also be expressed as [1] to [12] below. Yet, the standard sample containers and the automatic analyzers are not bound by these expressions, either.

### [1] Measurement With Standard Sample

An automatic analyzing apparatus for analyzing a sample by causing a reaction between the sample and a reagent in a reaction container, the automatic analyzing apparatus comprising: a standard sample storing part adapted to airtightly store a standard sample in a standard sample soft container such that the standard sample is not exposed to outside air; and a standard sample provider adapted to provide the standard sample to an analyzer, wherein the automatic analyzing apparatus is configured to perform measurement with the standard sample automatically or in response to a user operation when the measurement with the standard sample is necessary. (Note that the “standard sample soft container” may be called a “soft container”.)

### [2] Standard Sample Provider: Reagent Probe Utilizer

The automatic analyzing apparatus according to [1], wherein the standard sample provider comprises a reagent probe utilizer for the standard sample soft container to provide the standard sample to a reagent probe, wherein the reagent probe is configured to aspirate the standard sample through the reagent probe utilizer and provide the standard sample to an analyzing part. (Note that the “reagent probe utilizer” may be called a “take-out part”, and may include a check valve. Also, the “reagent probe” may be called a “dispensing probe”. The “analyzing part” may be called a “reaction container” or a “reaction tube”. The “reaction container” and the “reaction tube” are interchangeable with each other.)

### [3] Standard Sample Provider: Standard Sample Dispenser

The automatic analyzing apparatus according to [1], wherein the standard sample provider is adapted to provide the standard sample to an analyzing part using a standard sample dispenser which is connected to the standard sample soft container and adapted to dispense the standard sample.

### [4] Standard Sample Provider: Sampling Probe Utilizer

The automatic analyzing apparatus according to [1], wherein the standard sample provider comprises a sampling probe utilizer for the standard sample soft container to provide the standard sample to a sampling probe, wherein the sampling probe is configured to aspirate the standard sample through the sampling probe utilizer and provide the standard sample to an analyzing part. (Note that the “sampling probe utilizer” may be called a “take-out part”, and may include a check valve.)

### [5] Standard Sample Storing Part: Reagent Depository

The automatic analyzing apparatus according to [2] or [3], wherein the standard sample storing part and the standard sample provider are kept in a reagent depository.

### [6] Standard Sample Storing Part: Standard Sample Depository

The automatic analyzing apparatus according to [3], wherein the standard sample storing part and the standard sample provider are kept in a standard sample depository different from a reagent depository and a sampler. (Note that the “sampler” may be called a “disk sampler” or a “sample disk”.)

### [7] Standard Sample Storing Part: Sampler

The automatic analyzing apparatus according to [4], wherein the standard sample storing part and the standard sample provider are held in a sampler.

### [8] Standard Sample Provider: Reagent Depository

The automatic analyzing apparatus according to [5], wherein the standard sample provider is adapted to provide the standard sample to a first reaction container in an amount equal to or greater than an amount required for measurement, using the standard sample dispenser of a standard sample bottle or using the reagent probe, and wherein the standard sample in the amount required for measurement is provided from the first reaction container to a second reaction container using a sample dispensing probe. (Note that the “standard sample bottle” may be called a “standard sample container”. The “sample dispensing probe” may be called a “sample probe” or a “sampling probe”.)

### [9] Standard Sample Provider: Standard Sample Depository

The automatic analyzing apparatus according to [6], wherein the standard sample provider is adapted to provide the standard sample to a reaction container in an amount required for measurement, using the standard sample dispenser of a standard sample bottle.

### [10] Standard Sample Provider: Sampler

The automatic analyzing apparatus according to [7], wherein the standard sample provider is adapted to provide the standard sample to a reaction container in an amount required for measurement, using a sample dispensing probe.

### [11] Timing of Calibration Measurement

The automatic analyzing apparatus according to any one of [1] to [10], configured to perform a calibration measurement using a calibrator which is the standard sample, when a calibration curve or the reagent is expired or about to be expired or when the reagent is consumed or about to be consumed.

### [12] Timing of Controlled Measurement

The automatic analyzing apparatus according to any one of [1] to [10], configured to perform a controlled measurement using a control sample which is the standard sample, before a start of subject measurement, or upon elapse of a predetermined time since a previous controlled measurement, or upon preparation of a fresh calibration curve by a calibration measurement.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

1. A standard sample container comprising:
a soft container adapted to contain a standard sample for use in preparing a calibration curve or managing accuracy for an automatic analyzer;
a discharging mechanism adapted to discharge the standard sample present in the soft container into a reaction container via a dispensing nozzle; and
a chamber adapted to accommodate the soft container.

2. The standard sample container according to claim 1, further comprising:
a first valve at an end position in the discharging mechanism, the first valve adapted to block a back-flow from the dispensing nozzle toward an inside of the discharging mechanism; and
a second valve at a position in the discharging mechanism which is closer to the soft container than the first valve, the second valve adapted to block a back-flow from the discharging mechanism toward an inside of the soft container.

3. An automatic analyzer comprising:
the standard sample container according to claim 1; and
control circuitry configured to conduct measurement for preparing a calibration curve or measurement for managing accuracy, using the standard sample.

4. The automatic analyzer according to claim 3, further comprising a standard sample depository configured to keep, among the standard sample container and a reagent container, only the standard sample container.

5. The automatic analyzer according to claim 3, further comprising a sample dispensing probe configured to independently dispense a sample and the standard sample,
wherein the sample dispensing probe is configured to aspirate the standard sample from a first reaction container into which the standard sample has been dispensed from the standard sample container in an amount equal to or greater than a necessary amount, and to discharge the necessary amount of the standard sample among the aspirated standard sample into a second reaction container.

6. The automatic analyzer according to claim 3, wherein
the measurement for preparing the calibration curve is a calibration measurement, and
the control circuitry is configured to decide whether or not the calibration measurement is necessary based on at least one of a term of validity of a reagent, a remaining amount of the reagent, or a term of validity of the calibration curve.

7. The automatic analyzer according to claim 3, wherein
the measurement for managing the accuracy is a fresh controlled measurement, and
the control circuitry is configured to decide whether or not the fresh controlled measurement is necessary based on at least one of a presence or absence of a fresh calibration curve, or a time elapsed since a previous controlled measurement.

8. A standard sample container comprising:
a soft container adapted to contain a standard sample;
a housing adapted to enclose the soft container in a non-airtight state; and
a take-out part at a portion of the housing, the take-out part adapted to enable a dispensing probe to aspirate the standard sample present in the soft container.

9. An automatic analyzer comprising:
the standard sample container according to claim 8; and
control circuitry configured to conduct measurement for preparing a calibration curve or measurement for managing accuracy, using the standard sample.

10. The automatic analyzer according to claim 9, further comprising the dispensing probe,
wherein the dispensing probe is configured to independently dispense a reagent and the standard sample, and
to dispense the standard sample, the dispensing probe is configured to aspirate the standard sample through the take-out part and discharge the aspirated standard sample into a reaction container.

11. The automatic analyzer according to claim 10, further comprising a reagent depository configured to keep a reagent container and the standard sample container, the reagent container adapted to contain the reagent.

12. The automatic analyzer according to claim 9, further comprising a sample dispensing probe configured to independently dispense a sample and the standard sample,
wherein, to dispense the standard sample, the sample dispensing probe is configured to aspirate the standard sample through the take-out part and discharge the aspirated standard sample into a reaction container.

13. The automatic analyzer according to claim 12, further comprising a sampler configured to hold a sample container and the standard sample container, the sample container adapted to contain the sample.

14. The automatic analyzer according to claim 9, further comprising a standard sample depository configured to keep, among the standard sample container and a reagent container, only the standard sample container.

15. The automatic analyzer according to claim 9, further comprising a sample dispensing probe configured to independently dispense a sample and the standard sample,
wherein the sample dispensing probe is configured to aspirate the standard sample from a first reaction container into which the standard sample has been dispensed from the standard sample container in an amount equal to or greater than a necessary amount, and to discharge the necessary amount of the standard sample among the aspirated standard sample into a second reaction container.

16. The automatic analyzer according to claim 9, wherein
the measurement for preparing the calibration curve is a calibration measurement, and
the control circuitry is configured to decide whether or not the calibration measurement is necessary based on at least one of a term of validity of a reagent, a remaining amount of the reagent, or a term of validity of the calibration curve.

17. The automatic analyzer according to claim 9, wherein
the measurement for managing the accuracy is a fresh controlled measurement, and
the control circuitry is configured to decide whether or not the fresh controlled measurement is necessary based on at least one of a presence or absence of a fresh calibration curve, or a time elapsed since a previous controlled measurement.

18. An automatic analyzer comprising:
a rotary table configured to hold multiple reaction tubes in a rotatable manner; and
a reagent depository,
wherein the automatic analyzer is configured to dispense a sample into one of the reaction tubes that is located at a first position, and dispense a reagent from the reagent depository into one of the reaction tubes that is located at a second position, and
the automatic analyzer further comprises a dispenser adapted to dispense a standard sample kept in the reagent depository into one of the reaction tubes.

19. The automatic analyzer according to claim 18, further comprising a sample dispensing probe configured to dispense, after the dispenser dispenses the standard sample into said one of the reaction tubes at the second position, the standard sample present in said one of the reaction tubes into another one of the reaction tubes.

20. The automatic analyzer according to claim 19, wherein
when said one of the reaction tubes that contains the dispensed standard sample is moved to a position next to the first position, the sample dispensing probe aspirates the standard sample from said one of the reaction tubes and discharges the standard sample into another one of the reaction tubes that is located at the first position, and
when said another one of the reaction tubes that contains the discharged standard sample is moved to the second position, the reagent is dispensed into said another one of the reaction tubes at the second position.
